SEQUENCE LISTING (4 sequences)

SEQ ID NO: 1 - protein, 4 aa, Artificial Sequence
  artificial, sequence motif in elastin memetic protein
VPGG

SEQ ID NO: 2 - protein, 5 aa, Artificial Sequence
  artificial, sequence motif in elastin memetic protein
VPGVG

SEQ ID NO: 3 - protein, 6 aa, Artificial Sequence
  artificial, sequence motif in elastin memetic protein
APGVGV

SEQ ID NO: 4 - protein, 25 aa, Artificial Sequence
  artificial, sequence motif in elastin memetic protein
VPGVGVPGVGVPGVGVPGVGVPGKG

(19) United States
(12) Patent Application Publication
(10) Pub. No.: US 2004/0110439 A1
(43) Pub. Date: Jun. 10, 2004

(54) Native protein mimetic fibers, fiber networks and fabrics for medical use

(76) Inventors: Elliot L Chaikof, Atlanta, GA (US); Vincent Conticello, Atlanta, GA (US); Lei Huang, Duluth, GA (US); Karthik Nagapudi, Atlanta, GA (US)

Correspondence Address: Greenlee Winner and Sullivan, Suite 201, 5370 Manhattan Circle, Boulder, CO, 80303, US

(21) Appl. No.: 10/258,207

(22) PCT Filed: Apr. 20, 2001
(86) PCT No.: PCT/US01/12918

(51) Int. Cl. B32B 27/12; B32B 27/04

(52) U.S. Cl. 442/123

(57) ABSTRACT

The present disclosure provides spun fibers of proteins useful for the fibers, fiber networks and nonwoven fabrics for medical use, with these materials characterized by good biocompatibility properties (e.g., low tendency toward thromboses and inflammation when implanted into a human or animal). These materials can be fabricated from gelatin, collagen or elastin-mimetic proteins, functionalized proteins of the foregoing types, crosslinked functionalized proteins of the foregoing types, and there may be incorporated nonproteinaceous polymers and/or therapeutic proteins or other medicinal compounds. Additionally, there may be living cells colonized on the material of the present invention or living cells may be incorporated during the fabrication process. These materials can be used in medical applications including, without limitation, vascular grafts, reinforcement of injured tissue, wound healing, artificial organs and tissues, prosthetic heart valves and prosthetic ureters.

### ACKNOWLEDGMENT OF FEDERAL RESEARCH SUPPORT

This invention was made, at least in part, with funding from the National Institutes of Health, National Science Foundation and the NASA Research Agency. Accordingly, the United States Government may have certain rights in this invention.

### BACKGROUND OF THE INVENTION

The present invention relates to fibers, fiber networks and fabrics formed, at least in part, from synthetic elastin-mimetic proteins, functionalized elastin mimetic proteins including methacrylate-, vinyl- or acrylate-modified elastin-mimetic proteins, functionalized collagen such as acrylate-, vinyl- or or methacrylate modified collagen, flnctionalized gelatin modified in a similar manner to the foregoing proteins, collagen fibers, gelatin fibers, crosslinked collagen, gelatin or elastin mimetic fibers, and fiber networks and fabrics made using these materials.

Atherosclerosis is a serious cause of morbidity and death despite advances in preventive measures and pharmacological therapeutics. Nearly 700,000 vascular surgical procedures are performed annually in the United States, along with several hundred thousand peripheral and coronary angioplasties. Prosthetic bypass grafts and, more recently, arterial stents and other endovascular prostheses have been utilized in association with these reconstructive procedures. Although large diameter vascular grafts (≧6 mm internal diameter) have been successfully developed from polymers such as polytetrafluoroethylene and polyethylene terephthalate, the fabrication of a durable small diameter prostheses (≦6 mm internal diameter) remains unsolved. Furthermore, while prosthetic bypass grafting can be performed in the infrainguinal position with reasonable short-term success, within 5 five years 30% to 60% of these grafts will fail. Likewise, restenosis and/or occlusion occurs in as many as 50% of all patients within 6 months of stent placement, depending upon the site and the extent of the disease.

It is recognized that the adverse events leading to the failure of many vascular prostheses are related to maladaptive biological reactions at the blood-material and tissue-material interface. Grafts and stents have been coated with albumin, heparin, or prostacyclin analogues, which inhibit the clotting cascade and platelet reactivity, or with relatively inert materials, such as polyethylene oxide. An alternate approach has been to design arterial substitutes on the basis of tissue engineering principles in which a vessel construct is created using cultured endothelial cells, smooth muscle cells (SMC), and fibroblasts, which are reformulated to yield an artificial intima, media, and adventitia, respectively. Initial investigations utilizing this strategy have included seeding endothelial cells into the lumen of a compacted SMC/collagen tubular construct. This approach was limited by the requirement for a surrounding Dacron enclosure, which was necessary to provide adequate tensile strength for successful in vivo implantation. Cellular constructs with more robust mechanical properties have been produced by growing sheets of smooth muscle cells and fibroblasts in tissue culture flasks that are then rolled onto a mandrel and allowed to mature in vitro over a period of up to 12 weeks. When combined with reconstituted tubular sheets of freeze-dried collagen, burst strengths exceeded 2,000 mm Hg. The necessity for eight or more weeks of in vitro preconditioning has been reported despite utilization of an internal polyglycolic acid (PGA) scaffold onto which SMCs were seeded. Thus, all current tissue engineering approaches directed at the generation of a bioengineered blood vessel remain limited by a continued requirement for a several month preconditioning period, a surrounding synthetic polymeric sheath, or an internal synthetic biodegradable scaffold. Significantly, the use of a Dacron or PGA mesh does not recapitulate the biomechanical characteristics of a native blood vessel. Moreover, these synthetic materials uniformly induce an undesirable inflammatory response in the patient after implantation.

There is a longfelt need in the art for durable materials for medical and veterinary use in organ substitutes including, without limitation, blood vessels, heart valves, ligaments, tendons, and other load bearing prosthetic materials, as well as those materials to facilitate wound closing and/or healing, and where the resident tissue will benefit from reinforcement, where those materials are compatible with human and animal physiologies such that thromboses, inflammation and other harmfuil physiological reactions are not induced. It is also important that there be durable and biologically compatible materials which do not require lengthy preconditioning periods prior to implantation in a patient in need of the prosthetic material.

### SUMMARY OF THE INVENTION

The present invention pÑrovides biologically compatible protein fibers, fiber networks, fabrics and crosslinked fibers for use in medical and veterinary applications. These materials are characterized by resilience, flexibility, extensibility, tensile strength, mechanical strength and ability to recover shape after distortion, similar to that of native proteins in biological materials. The present materials, especially those which comprise crosslinked elastin, crosslinked elastin mimetic protein, crosslinked collagen and/or crosslinked gelatin, are especially useful in the medical or veterinary area because of the similarity of the physical properties of the materials as well as the biological compatibility which is improved over many synthetic materials which induce inflammation and/or thrombosis, depending on the site used. Functionally modified elastin, elastin mimetic protein, collagen and gelatin can also form the materials of the present invention. Alternatively, crosslinked proteinaceousibers, networks and nonwoven fabrics can be form of proteins which are crosslinked with glutaraldehyde treatment or other means known to the art which preserves the desirable physical properties of the material, i.e., flexibility, entensibility, tensile strength and the like.

The present invention provides elastin mimetic proteins and crosslinked materials formed into fibers, fiber networks, fabrics and tubing. The fibers can be in the form of thin filaments, beaded fibers or ribbon like structures, with fiber diameters from about 200 to about 3000 nm, depending on the electrospimiing conditions as taught hereinbelow. These materials can optionally include at least one additional material which is fiber-forming but which does not include functional groups which can mediate crosslinking such as poly(ethylene oxide) which provides some physical strength to the material and again, optionally, a biologically active material such as a therapeutic protein or other pharmacologically compound. A polysaccharide can also be incorporated. The fiber morphology and physical properties are affected by the PEO molecular weight as well as by the relative amount of PEO in the fiber forming solution. The PEO dissolves relatively slowly under physiological conditions, which can provide for release of the additional material(s). Anti-inflammatory agents and/or growth factors which stimulate wound healing or tissue repair and antitumor agents are but a few of the biologically and pharmacologically agents which occur to one of ordinary skill in the art for inclusion in the material of the present invention. The skilled artisan knows how to choose a therapeutic protein or other compound according to the needs of the human or animal patient in which the material is used. Where the fibers are to be crosslinked prior to use, an initiator of crosslinkage, e.g., a photoinitiator, can be incorporated into the solution from which the fibers are spun, with the result that the initiator is then present within the fiber.

The present invention further provides improved prosthetic materials for medical and veterinary use. These materials are formed of functionally modified elastin mimetic fibers which have been crosslinked using photoinitiators (i.e., under relatively mild conditions with respect to free radicals and temperature) and photoirradiation, and/or collagen or gelatin fibers which are crosslinked. Prosthetic materials can include, without limitation, tubing for vascular prostheses, ureters, esophagus, bladder, intestine, heart planar materials for use in reinforcing injured tissues (cartilage, tendons, heart valves, heart muscle, bladder, esophagus, ligament, stomach, among others) and for use as topical applies materials for promoting wound healing after injury or in facilitating healing of surgical incisions (including without limitation intestinal anastomeses or lung biopsy) or remediation of hernias. Crosslinking can be effected after casting each protein layer or crosslinking can take place after a multilayer material has been produced. Where used in surgical applications, hydrophilic polysaccharides and/or glycopolymers can be incorporated to reduce adhesion formation after surgical intervention by placing the material at the surgical site.

Within the scope of the present invention are hybrid elastin/collagen materials, which can be formed by depositing alternating layers of elastin or an elastin mimetic protein, either as protein fibers or as cast films of native protein and/or elastin mimetic protein and collagen or functionalized collagen. Nonwoven fabrics are especially useful products of the present invention. The functionally modified elastin or elastin mimetic protein and/or collagen can be crosslinked once formed into nonwoven fabrics for improved stability, resistance to dissolution and improved physical properties. An advantageous aspect of the present invention is a lamellar repeat of an elastin mimetic layer sandwiched between collagen layers. The nonwoven fabric of this aspect of the invention can have from one lamellar repeat up to about ten thousand sequentially layered lamellar repeats. The thickness of each lamellar repeat layer affects the ultimate physical properties of the product.

It is a further aspect of the present invention to provide an elastin, elastin mimetic, elastin mimetic/collagen hybrid, gelatin or collagen nonwoven fabric which furher comprises living cells. The living cells can be at least one of, but not limited to endothelial cells, smooth muscle cells, fibroblasts, stem cells, chondrocytes, osteoblasts or a human or animal cell which has been genetically engineered to produce a protein of interest. The protein of interest can be a growth factor which could promote wound healing, or a peptide hormone such as insulin in the context of an artificial organ, or an antiangiogenic protein to be used in an antitumor application, and others will readily occur to one of ordinary skill in the art. The living cells can be incorporated between lamellar repeat units, and the cells can be deposited by techniques including, but not limited to, electrodeposition and sedimentation.

The materials of the present invention can be used in the form of conduits, or planar sheets or they can be formed into other shapes by rolling to form hollow tubing or by sequential deposition onto a rotating mandrel or other forms or molds.

### BRIEF DESCRIPTION OF THE DRAWINGS

FIGS. 1A-1B show the Vₛₜₐᵣₜ and Vₛₜₒₚ for various solution concentrations (FIG. 1A) and corresponding viscosities (FIG. 1B) of elastin-mimetic peptide aqueous solutions.

FIGS. 2A-2D present SEM micrographs of elastin-mimetic peptide fibers spun from 5 wt % solution at 50 μl/ml (FIG. 2A), 100 μl/ml (FIG. 2B), 150 μl/ml (FIG. 2C), 200 μl/ml (FIG. 2D) flow rate.

FIGS. 3A-3D present SEM micrographs of elastin-mimetic peptide fibers spun from 10 wt % solution at 50 μl/ml (FIG. 3A), 100 μl/ml (FIG. 3B), 150 μl/ml (FIG. 3C), 200 μl/ml (FIG. 3D) flow rate.

FIGS. 4A-4D present SEM micrographs of elastin-mimetic peptide fibers spun from 15 wt % solution at 50 μl/ml (FIG. 4A), 100 μl/ml (FIG. 4B), 150 μl/ml (FIG. 4C), 200 μl/ml (FIG. 4D) flow rate.

FIGS. 5A-5D present SEM micrographs of elastin-mimetic peptide fibers spun from 20 wt % solution at 50 μl/ml (FIG. 5A), 100 μl/ml (FIG. 53B), 150 μl/ml (FIG. 53C), 200 μl/ml (FIG. 5D) flow rate.

FIGS. 6A-6D are high resolution SEM (FIGS. 6A and 6B) and TEM (FIGS. 6C and 6D) micrographs of elastin-mimetic peptide fibers spun from a 20% wt % solution at 100 ∥l/ml flow rate, which demonstrate a twisted ribbon-like morphology.

FIGS. 7A-7B are SEM micrographs (FIGS. 7A and 7B) of a non-woven fabric spun from a 15% wt. solution of elastin-mimetic peptide at 150 μl/ml.

FIG. 8 illustrates fiber diameter distribution within a non-woven fabric spun from a 15 wt % solution of elastin-mimetic peptide at 150 μl/ml.

FIG. 9 shows distribution of fiber orientation within a non-woven fabric spun from a 15 wt % solution of elastin-mimetic peptide at 150 μl/ml.

FIG. 10 is a representative uniaxial stress-strain curve for drying a non-woven fabric of elastin-mimetic peptide fibers.

FIGS. 11A shows ¹H NMR spectra of elastin and elastin methacrylamide measured in D₂O (*) at room temperature. Expanded region of the protons corresponding to the double bonds (H^{a}, H^{b}) is also shown for the elastin methacrylamide spectrum. FIG. 11B shows an expanded version of the figure between 2.6 and 3.1 ppm. The spectra indicate the shift in the methylene protons α to the amino group prior (H^{c}) and subsequent (H^{d}) to methacryloylation.

FIG. 12 shows ¹H NMR spectra of elastin and AME. The DOF of AME's is provided in the brackets. The expanded portion of the spectra between 2.6 and 3.1 ppm. As DOF increases the H^{d} peak grows in intensity at the expense of the H^{c} peak. The DOF can be computed from the integrated intensities of the H^{c} and H^{d} peaks.

FIG. 13 shows temperature-dependent turbidimetry data for elastin and acrylate-modified elastin with different degrees of functionalization. The inverse transition temperature (Tₜ) decreases with increase in the degree of functionalization (DOF). DOF dictates the temperature (processing window) at which fibers can be formed from aqueous solutions. The temperature window to the left of Tₜ is amenable for fiber formation.

FIG. 14 shows SEM micrographs of fibers spun from a 10 wt % AME(65) solution at room temperature. Flow rate=50 μl/min, Photoinitiator=EY (3 wt % of protein content). Long uniform fibers are produced with occasional triangle type bifurcation points. Fibers in the diameter range from 300-500 nm were produced.

FIG. 15 presents SEM micrographs of fibers spun from a 15 wt % AME(65) solution at room temperature. Flowrate=50 μl/min, Photoinitiator=EY (3 wt % of protein content). Long uniform fibers are produced with a flattened or ribbon shaped morphology. Fibers in a variety of diameter ranges are produced (typically from 300 nm-2 μm).

FIG. 16 shows ¹³C CP/MAS/TOSS spectra of elastin-mimetic polypentapeptide, methacrylate-modified elastin and crosslinked elastin recorded at room temperature (23° C.). Contact time=1 ms and spinning speed (ωᵣ/2π)=5 kHz. Disappearance of the peaks C^{a} and C^{b} in the spectrum for the crosslinked material indicate complete crosslinking after exposure either to UV at 365 nm or visible light. The peaks labeled “*” are from the photoinitiator Irgacure 2959®) employed for crosslinking.

FIG. 17 illustrates degree of crosslinking of AME(88) determined by ¹³C solid-state NMR as a function of irradiation time. Data presented as mean ±standard deviation.

FIG. 18(A) shows a stress-strain curve of crosslinked and uncrosslinked fabric samples of elastin methacrylamide in the dry state. Crosslinking increases both tensile strength and modulus of the sample. FIG. 18B shows stress-strain curves of dry and hydrated (O) crosslinked AME(65) fabric samples of elastin methacrylamide measured at a strain rate of 1 mm/min at room temperature.

FIGS. 19A-19D are SEM micrographs of collagen-PEO (1:1) fibers spun from 2wt % acid solution at a flow rate of 100 μL/min and at different NaCl concentrations: FIG. 19A, 15 mM NaCl, 10 k× magnification; FIG. 19B, 25 mM NaCl, 5 k× magnification; FIG. 19C, 34 mM NaCl, 2 k× magnification; and FIG. 19D, 68 mM NaCl, 5 k× magnification.

FIGS. 20A-20D are SEM micrographs of collagen-PEO (1:1 (w/w), 34 mM NaCl) fibers spun from 2 wt % acid solution at different flow rates (μL/min): FIG. 20A, 25; FIG. 20B, 75; FIG. 20C, 100; and FIG. 20D, 150.

FIG. 21 shows ¹³C MAS spectra of collagen, PEO and a 1:2 collagen-PEO blended fabric. The CP spectrum of the blend appears to be a simple superposition of the CP spectrum of PEO (*) and collagen (C). The DP spectrum of the blend (DP discriminates against the more rigid components) shows that PEO is highly mobile in the sample when compared to collagen at the measuring temperature (24° C.).

FIG. 22A shows the ¹H NMR spectrum of 1:2 collagen-PEO fabric is shown before and after the application of the dipolar filter. The dipolar filter eliminates the broad component of the spectrum and retains the narrow component. FIG. 22B shows the ¹³C CP/MAS/TOSS spectra before and after application of the dipolar filter. After selection, only the PEO resonance is retained demonstrating that effective selection of mobile component has been achieved using the dipolar filter.

FIG. 23 provides spin diffusion data for 1:1 and 1:2 collagen-PEO fabrics. The initial portion of the curve, corresponding to times less than 9 ms, is shown in the inset. The data illustrates the presence of an interface for a 1:1 blend while showing no appreciable interface for a 1:2 blend. The dotted lines indicate the theoretical end point values for spin difflision in case of 1:1 (●) and 1:2 (□) blends.

FIG. 27 provides the ¹³C CP/MAS/TOSS solid-state spectra of gelatin methacrylamide and crosslinked gelatin methacrylamide (MAS rate=6 kHz). The inset shows the resonances from the double carbons (a, b). Spectrum of the crosslinked sample was collected on a film sample which was irradiated under visible light for 2 hours. The disappearance of the double bonds indicates complete crosslining in the sample.

FIG. 28A-28B depict nonwoven crosslinked tubes of gelatin methacrylamide (FIG. 28A) prior to hydration and (FIG. 28B) in hydrated state. A 5 cm 14 mm tube is shown.

FIG. 29A shows the diffusion profiles obtained from PFGNMR measurements for varying diffusion times are shown as a function of the magnetic field gradient. FIG. 29B shows the 1000-ms profile in (a) has been remade showing the normalized intensity as a function of a parameter

$${α}^{2} ( {α}^{2} = \frac{{γ}^{2} {δ}^{2} {G}^{2}}{5} ) .$$

The data has been fitted to a Gaussian distribution of pore sizes.

FIG. 30A-30B provide a comparison of data between natural systems and electrospun fabrics produced in the lab. FIG. 30A shows the stress-strain behavior of human iliac artery, data from Roach M. R. and Burton A. L. (1957) Can. J. Biochem. Physiol. 35: 681, 1957. FIG. 30B shows the stress-strain behavior of crosslinked collagen and elastin fabrics produced by electrospinning. The mechanical behavior of the fabricated materials qualitatively mimics the behavior of natural artery.

### DETAILED DESCRIPTION OF THE INVEION

Abbreviations used in the present application include the following: PEO, poly (ethylene oxide); PGA, polyglycolic acid; AME, acrylate modified elastin (or elastin mimetic); DOF, degree of functionalization; DCC, dicyclohexylcarbodiimide; DDG, 2,3-dichloro-5,6-dicyano1,4-benzoquinone; DMAP, N,N-dimethylaminopyridine; EY, eosin Y; FITC, fluorescein isothiocyanate; NHS-Biotin, N-hydroxysuccinimidobiotin; EMC, -ε-maleimidocaproyl; EMCS, -ε-maleimidocaproyl succinimide; PMB, p-methoxybenzyl; Troc-amide, 2, 2, 2-trichloroethoxyamide; PEU, poly(ether urethaneurea); PFTE, polytetrafluoroethylene; ePFTE, expanded polytetrafluoroethylene; HEA, 2-hydroxyethyl acrylate; AOD, 3-acryloyl-e-3-(N,N-dioctadecylcarbamoyl propionate); AAPD, 2,2′-azobis(2-methylpropionamidine) dihydrochloride; AIBN, 2,2′-azobisisobutyronitrile; SS, styryl sulfonate. Standard one- and three-letter abbreviations for the twenty naturally occurring, protein building block amino acids are used herein.

As part of our program in biomimetic materials and tissue engineering, we have targeted several elements of the arterial wall as structural models for the design of an artificial blood vessel based upon the assembly of component structures. The arterial wall as representative of other tissues and organ systems can be considered in general terms as a fiber-reinforced composite material with associated mechanical properties largely a consequence of protein fiber networks. Moreover, the local mechanical environment within the vessel wall may in turn influence the functional responses of component cells.

Biocompatibility (or biological compatibility) refers to the interactions of living body tissues, compounds and fluids, including blood, etc., with any implanted or contacting material (biomaterial). Biocompatible biomaterials are of great importance in any biomedical application including, for example, in the implantation of vascular grafts and medical devices such as artificial organs, artificial heart valves, artificial joints, catheters and various other prosthetic devices into or on the body. Biomaterials with good biocompatibility do not trigger inflammatory reactions after implantation in or contact with human or animal tissue nor do they provide surfaces which are prone to thromboses.

In the context of the present invention, a functionalized protein is one which has, covalently bound to it, at least one moiety which mediates polymerization or crosslinkage with another moiety of the same chemical structure. The functionalized elastin mimetic protein, elastin, collagen or gelatin of the present invention comprise at least one polymerizable monomeric group, e.g., an acryloyloxy group, methacryl, dienyl, sorbyl, styryl, acrylamide, acrylonitrile, N-vinyl pyrrolidone, etc., which group is covalently attached to the protein and which modulates crosslinking between similarly functionalized proteins. Desirably, photoirradiation mediates the crosslinking reaction in the presence of a suitable photoinitiator, under mild conditions of temperature and radical formation to minimize damage to the proteins. Functionalization of the protein is carried out so that the desirable mechanical and structural properties ofthe protein superstructure comprised of it are generally maintained. Conditions and initiators for crossliking reactions are well known to the art.

As used herein, an elastin mimetic protein is one which has an amino acid sequence and secondary structure derived from native (naturally occurring) elastin. As specifically exemplified herein, the elastin mimetic protein is recombinantly produced in Escherichia coli, and it is described in McMillan et al. (1999) Macromolecules 32: 3643-3648. This elastin mimetic protein contains 39 repeats ofthe amino acid sequence (Val-Pro-Gly-Val-Gly)₄(Val-Pro-Gly-Lys-Gly) (SEQ ID NO:4). See also Huang et al. (2000) Macromolecules 33: 2989-2997 and McMillan et al. (2000) Macromolecules 33: 4809-4821. It is critical that it has elastomeric properties and tensile strength similar to those elastin when assembled into supramolecular structures such as fibers, fiber networks and nonwoven fabrics.

Elastomeric proteins are widely distributed among a diverse range of animal species and tissues where they have evolved precise structures to perform specific biological functions. These proteins, which include for example, abductin [Cao et al. (1997) Curr. Biol. 7: R677-8], tropoelastin [Gray et al. (1973) Nature 246: 461-6; Sandberg et al. (1981) N. Engl. J. Med. 304: 566-579; Urry et al. Ed., Birkhauser: Boston, 1997, pp 133-177] bysuss [Deming, T. J. (1999) Curr. Opin. Chem. Biol. 3: 100-5], silk [Hayashi et al. (1999) Int. J. Biol. Macromol. 24: 271-5; Hayashi, C. Y. and Lewis, R. V. (1998) J. Mol. Biol. 275: 773-84], and titin all possess rubber-like elasticity, undergoing high deformation without rupture, storing energy involved in deformation, and then recovering to their original state when the stress is removed. The ability of proteins to exhibit rubber-like elasticity relates both to their primary and secondary structure, as well as to those features, such as protein self-assembly and other intermolecular interactions that dictate the formation of true or virtual networks. Elastomeric materials must satisfy two criteria. First, in order to respond quickly to an applied force, the monomers, which in elastomeric proteins typically consist of repetitive glycine-rich peptide motifs, must be flexible and conformationally free. Second, elastomeric macromolecules must be crosslinked to form a network. Characteristically, elastic proteins combine elastomeric domains with domains that form covalent or noncovalent crosslinks. Thus, the size and properties of the elastic domains and the degree of crosslinking influence the elastic behavior of protein-based materials. Tensile strength is important in certain applications, and collagen and gelatin and crosslinked acrylate modified collagen improves the tensile strength of artificial fibers, fiber networks and fabrics and the like.

Elastin, which is derived from the soluble precursor tropoelastin, is widely distributed in vertebrate tissues. The elastin protein consists of repetitive glycine-rich hydrophobic elastomeric domains of variable length that alternate with alanine-rich, lysine-containing domains that form crosslinks [Sandberg et al. (1981). N. Engl. J. Med. 304: 566-579; Urry.et al., Ed.; Birkhauser: Boston, 1997, pp 133-177; Sandberg et al. (1981). N. Engl. J. Med. 304: 566-579; Urry et al., Ed.; Birkhauser: Boston, 1997, pp 133-177]. Native elastin's intrinsic insolubility has largely limited its capacity to be purified and processed into forms suitable for biomedical or industrial applications. Recently, this limitation has been largely overcome, in part, by the structural characterization of the elastomeric domains. Specifically, comprehensive sequence analysis has revealed the presence of consensus tetra- (VPGG), penta-(VPGVG), and hexapeptides (APGVGV) repeat motifs [Gray et al. (1973) Nature 246: 461-6; Urry et al. (1975) Biochim. Biophys. Acta 393: 296-306; Sandberg et al. (1977) Adv. Exp. Med. Biol.79: 277-84; Khaled et al. (1976) J. Am. Chem. Soc. 98: 7547-53; Rapaka et al. (1978) Int. J. Pept. Protein Res. 11: 109-27; Urry et al. (1986) Int. J. Pept. Protein Res. 6: 28, 649-660; Broch et al. (1998) Biomol. Struct. Dyn. 15: 1073-1091]. VPGG, VPGVG and APGVGV are given in SEQ ID NO:1, SEQ ID NO:2 and SEQ ID NO:3, respectively. Polymers of the pentapeptide exhibit elastic behavior with spectroscopic features, including a highly mobile backbone and the presence of β-turns and a loose helical β-spiral, that are consistent with those of native elastin [Urry et al. (1974) Biochemistry 13: 609-16; Urry et al.(1985) Biopolymers 24: 2345-2356]. Thus, the pentapeptide sequence (VPGVG) (SEQ ID NO:2) has formed the basis for the synthesis of protein polymers with elastomeric domains by standard solution and solid phase chemical methodologies and, more recently, by genetic engineering strategies [McPherson et al. (1992) Biotechnology Progress 8: 347-352; McPherson et al. (1996) Protein Expression Purification 7: 51-57; Panitch et al. (1999) Macromolecules 32: 1701-1703; McMillan et al. (1999) Macromolecules 32: 3643-3648; McMillan R. A. and Conticello, R. P. (2000) Macromolecules 33: 48094821].

In tissues, such as arterial blood vessels, where energy and shape recovery are critical parameters, elastin networks dominate low strain mechanical responses. Avoidance of artery wall fatigue and failure is dependent upon the resilience of elastin, which prevents the dissipation of transmitted pulsatile energy as heat. While elastin fibers are structurally complex and may contain glycoproteins and glycosaminoglycans, the physical properties of the network have been attributed primarily to the elastin protein component produced from the soluble precursor tropoelastin [Debelle et al. (1999) Internat. J. Biochem. Cell Biol. 31:261-272]. Furthermore, extensive investigations by Urry and others [Urry et al. (1985) Biochem. Biophys. Res. Commun. 130: 50-57; Thomas et al. (1987) Biopolymers 26:921-934; Urry, D. W. (1988) J. Prot. Chem. 7: 1-34; Chang et al. (1988) Chem. Phys. Lett. 147: 395-400; Urry et al. (1989) Biopolymers 28: 819-833; Chang et al. (1989) J. Biomolec. Struct. Dyn. 6: 851-858; Urry, D. W. (1993) Angew. Chem. Int. Ed. Engl. 32: 819-841; Urry et al. (1995) Ciba Foundation Symposium 192: 4-30; Urry et al. Ed.; Birkhauser: Boston, 1997, pp 133-177; Sandberg et al. (1977) J. Adv. Exp. Med. Biol. 79: 277; Foster et al. (1973) J. Biol. Chem. 24:2876; Sandberg et al. (1985) Pathol. Biol. 33:266-274; Wasserman et al. (1990) Biopolymers 29:1613-1628) since the mid-1970s have revealed that the molecular folding and/or self-assembly of tropoelastin into more ordered structures, as well as its elastomeric nature are due to the frequent appearance of a pentapeptide unit (Valine-Proline-Glycine-Valine-Glycine; SEQ ID NO:1). The presence of lysine residues along the native protein backbone facilitates intermolecular crosslinking, which further influences the mechanical responses of the elastin fiber network. Model polymers based upon the pentapeptide sequence have been synthesized by solution chemistry and solid phase approaches [Urry et al. (1985) Syntheses, Characterizations and Medical Uses of the Polypentapeptide of Elastin and its Analogs; William D. F. Ed.; CRC Press: Boca Raton, Fla.] and recently by more efficient recombinant genetic engineering methodologies [McPherson et al. (1992) Biotechnology Progress 8: 347-352; McPherson et al. (1996) Protein Expression Purification 7: 51-57; Panitch et al. (1999) Macromolecules 32: 1701-1703; McMillan et al. (1999) Macromolecules 32: 3643-3648]. These protein polymers have been processed into elastomeric hydrogels of various forms including sheets and tubular constructs by chemical, enzymatic, and γ-irradiation mediated crosslinking of protein solutions [Urry et al (1997) supra]. These polymers have also been used in generating thin films. For example, Panitch et al. (1999) supra have produced elastin-like protein polymers containing a periodically spaced cell binding fibronectin CS5 domain. When cast from solution onto an otherwise non-adhesive substrate, these polymers promoted cell adhesion and growth. Efficient processing strategies, which can convert elastin peptide polymers into fibers and networks that mimic native structures, enhance the utility of these materials.

The production of fibers from protein solutions has typically relied upon the use of wet or dry spinning processes [Martin et al. Processing and Characterization of Protein Polymers; McGrath, K. and Kaplan, D., Ed.; Birkhauser: Boston, 1997, pp.339-370; Hudson, S. M. The Spinning of Silk-like Proteins into Fibers; McGrath, K. and Kaplan, D., Ed.: Birkhauser: Boston, 1997, pp. 313-337]. Wet spinning, more commonly used, involves the extrusion of a protein solution through a spinneret into an acid-salt coagulating bath, which usually contains aqueous ammonium sulfate, acetic acid, isopropanol, or acetone. Alternatively, dry spi ing consists of extrusion into an evaporative atmosphere. Both approaches yield large diameter fibers which do not mimic the morphological characteristics of native protein fibers. O Furthermore, both strategies rely on biologically toxic solvent systems that preclude the fabrication in real time of hybrid protein-cell constructs. Electrospinning is a third approach that has been recently utilized to generate protein fibers [Reneker et al. (1996) Nanotechnology 7: 216223; Doshi et al. (1995) J. Electrostatics 35: 151-160]. In this technique, a polymer solution is subjected to an electric field that induces the accumulation of charge on the surface of a pendent drop. Mutual charge repulsion causes a force which directly opposes that produced by surface tension. At a critical value of electric field strength, a repulsive electric force exceeds the surface tension force, and a charged jet of solution is ejected. The jet splays into a series of fine filaments with a range of diameters that are characteristically on the order of several tens or hundreds of nanometers. Given the high surface area to volume ration of these nanofibers, solvent evaporation occurs relatively quickly even when operating with aqueous solutions at ambient temperature and pressure. Several examples of protein nanofibers produced by the application of electrospinning techniques have been reported. Anderson et al. have electrospun a series of silk-like protein polymers from formic acid and investigated their capacity to modify the cell adhesive characteristics of an underlying solid substrate [Anderson et al. Bioactive Silk-like Protein Potymer Films on Silicon Devices; Alper, M., Bayby, H., Kaplan, D. and Navia, M., ed.; Materials Research Society: Pittsburgh, Pa.; 1994, Vol. 330, pp. 171-177.

We describe herein fiber formation from natural elastin, a recombinant elastin mimetic polypeptide, from collagen and from gelatin. Electrospinning techniques were employed to produce fibers in a form that mimics native elastin fiber diameter utilizing an 81 kD synthetic elastin peptide polymer based upon the elastin-mimetic repeat sequence (Val-Pro-Gly-Val-Gly)₄(Val-Pro-Gly-Lys-Gly) (SEQ ID NO:4). The effects of process parameters on fiber morphology including solution viscosity, flow rate, electric field strength, and the distance between the spinheret tip and the collecting surface were defined. In addition, non-woven fabrics based upon this elastin analogue were produced, and component fiber properties, including the distribution of fiber diameter and orientation, were characterized. A framework has been established for investigating the influence of fiber processing on both the structural features and mechanical properties of single protein fibers and fiber networks formulated as non-woven fabrics. As a consequence, the capacity to engineer tissue like constructs whose mechanical and biological properties are based upon a hierarchical arrangement of protein networks has been significantly enhanced.

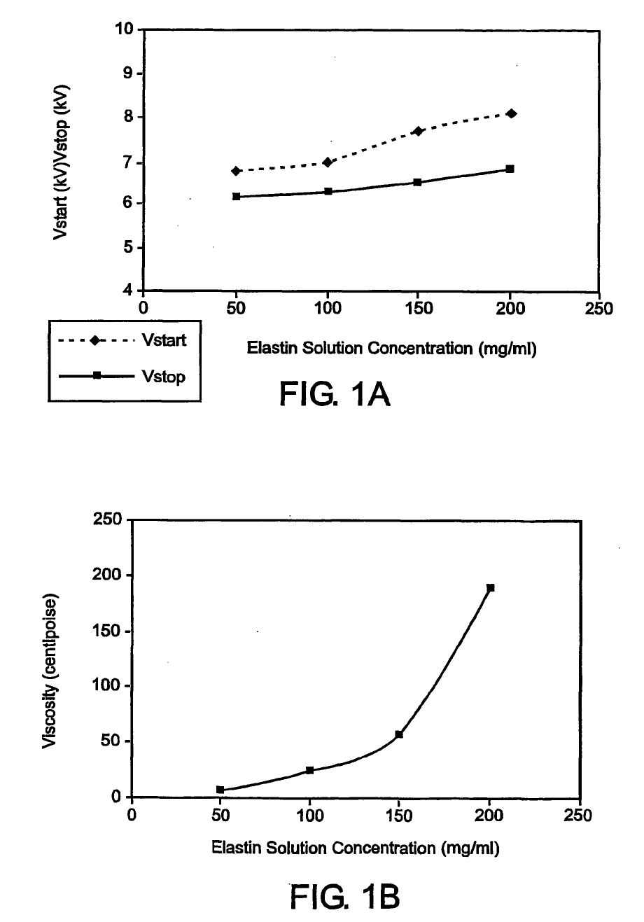

Initial investigations focused on defming the electric potential necessary to initiate or terminate jet formation from aqueous solutions of the elastin analogue. Overall, values for both Vₛₜₐᵣₜ and Vₛₜₒₚ were proportionately related to the concentration of the peptide in solution and the corresponding viscosity (FIG. 1). Vₛₜₐᵣₜ was greater than 6.4 kV for all concentrations tested, and the splay was found to be unstable above 25 kV. Therefore, 18 kV was the chosen field strength for subsequent fiber formation investigations. Jet instability was observed at concentrations above 20 wt %, with an accompanying inability to form fibers. A systematic study of the influence on fiber morphology of the distance between the spinneret tip and the collecting plate revealed that 15 cm was an optimal distance for fiber formation.

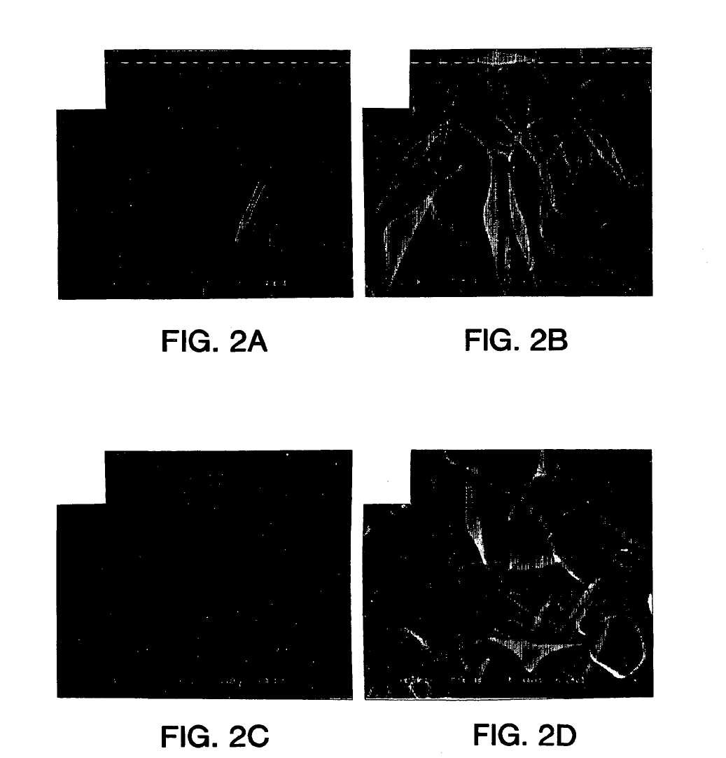

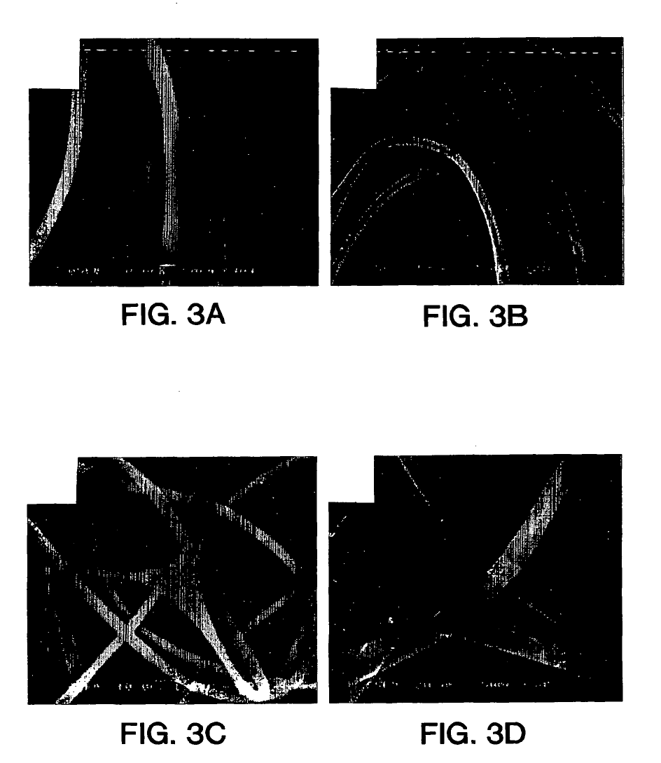

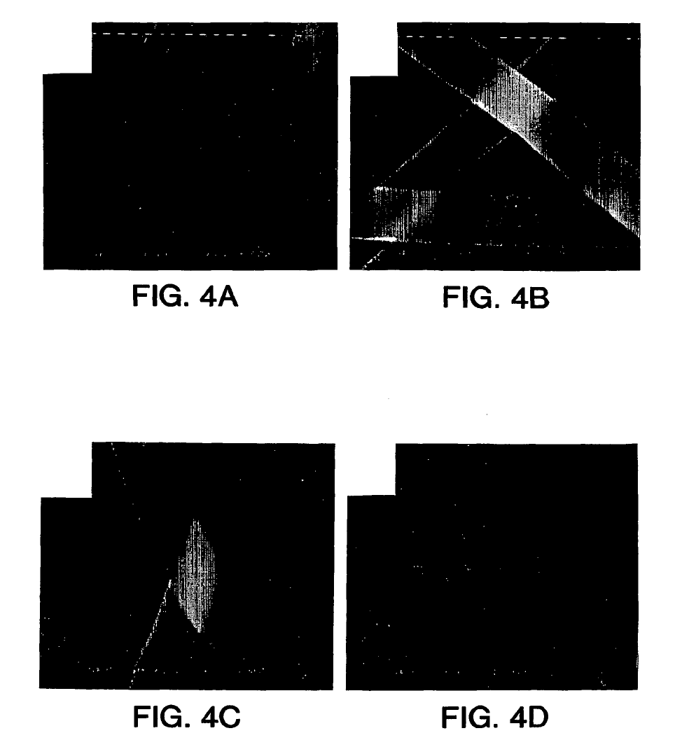

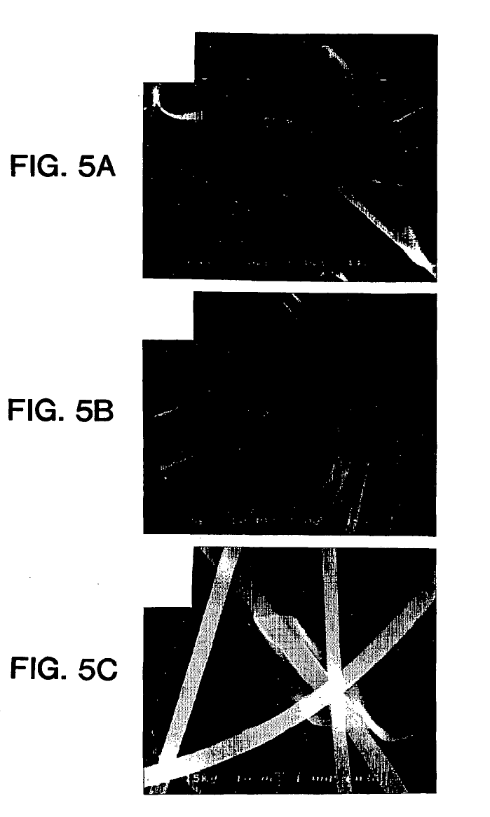

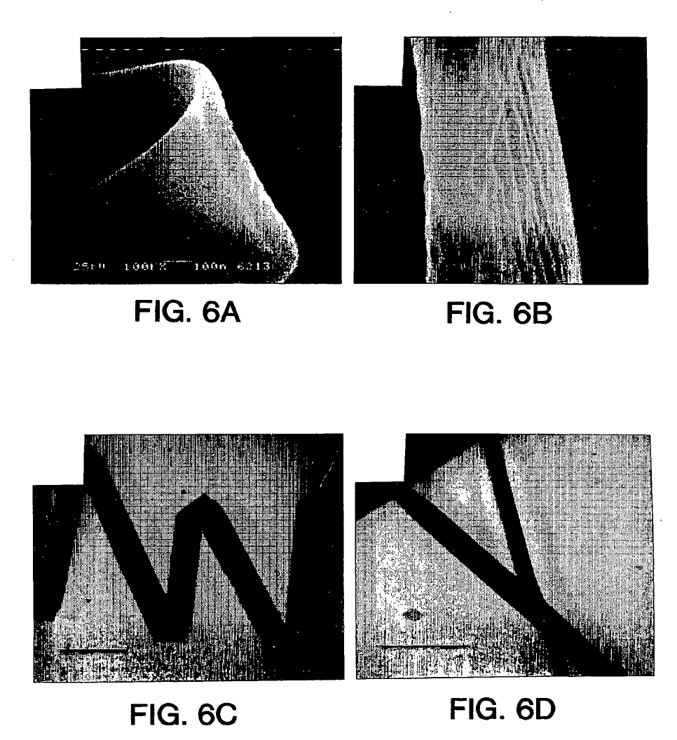

The major determinants of fiber morphology are solution concentration and flow rate. Fibers formed from a 5 wt % solution, regardless of the mass flow rate, are short, fragmented and characterized by a triangular or spindle shaped beaded morphology (FIG. 2). Long uniform fibers were generated at solution concentrations above 10 wt % which corresponded to solution viscosities greater than 25 centipoise (FIG. 3). Fiber diameters range between 300 and 400 nm over all flow rates tested with little variation in morphology with the infrequent exception of fiber splitting at triangle-shaped bifurcation points. At a flow rate of 100 μl/min, it was estimated that 1500 meters of thin filament were produced per minute. At solution concentrations of 15 and 20 wt %, a new morphological pattern was noted: flattened or ribbon shaped fibers which appeared, on occasion, twisted during the spinning and deposition process (FIGS. 4, 5). The formation of ribbon shaped fibers from the 20 wt % solution was a relatively common occurrence with an average fiber width of approximately 3.0 μm. However, both thin filaments (250-600 nm) and wider ribbon-like structures (˜3 μm) were observed together, particularly when fibers from this solution were formed at low flow rates. Molecular-level microstructure was observed on the surface of elastin-like ribbons, characterized by aligned axially oriented ridges with an apparent height and width of 10 to 20 nm (FIG. 6). Although twisted ribbons were also examined by TEM, additional higher order structural features were not observed.

Fong et al. (1999) Polymer 40: 4585-4592, have reported that a solution viscosity of at least 500 centipoise was required for effective electrospinning of non-beaded fibers from aqueous solutions of high molecular weight poly(ethylene oxide) ( 900 kD). In contrast, a relatively low viscosity solution (25 centipoise) of elastinpeptide polymer yielded electrospun fibers of uniform diameter. This phenomenon is believed to be related to molecular self-assembly processes that are operative for the elastin analogue and, thereby, may be an important deterrninant of thin filament and ribbon formation at low and high solution concentrations, respectively. Urry et al. (1988) supra and (1989) supra have noted that the central “Pro-Gly” element of the pentapeptide repeat (Val-Pro-Gly-Val-Gly) (SEQ ID NO:2) adopts a type II reverse turn structure, forming a flexible helix or “β-spiral” on tandem sequence repetition. Specifically, a conformational rearrangement from a random coil to a β-spiral structure has been noted for model poly(VPGVG) (SEQ ID NO:2)peptides on phase separation of the polymer. This conformation promotes both intra- and intermolecular hydrophobic interactions and underlies the elastomeric restoring force in elastin. Therefore, during the process of nanofiber formation, progressive solvent loss probably reduces the inverse transition temperature of the peptide solution, facilitating both hydrophobically mediated polypeptide folding and molecular self-assembly. Under appropriate conditions in vitro, tropoelastin molecules have a well-known tendency to aggregate into thin filaments. Likewise, the formation of elastin filaments in vivo, as basic building blocks of larger elastin fibers, has been observed by atomic force microscopy and high resolution cryoelectron microscopy [Pasquali-Ronchetti et al. (1995) Ciba Foundation Symposium 192: 31-50; Pasquali-Ronchetti et al. (1998) Matrix Biology 17: 75-83]. These studies have demonstrated that native elastin fibers can be resolved into a threedimensional bundle of 7 nm wide filaments oriented in the direction of the fiber. High resolution SEM of electrospun elastin fibers revealed the presence of 10 nm wide filament-like surface folds runing parallel to the direction of the fiber. Given reported electrospinning strain rates on the order of 10⁴s⁻¹, it is conceivable that elongational flow promotes the orientation and self-assembly of polymer molecules in the direction of elongation [Reneker et al. (1995) Bull Am. Phys. Soc. 40: 351].

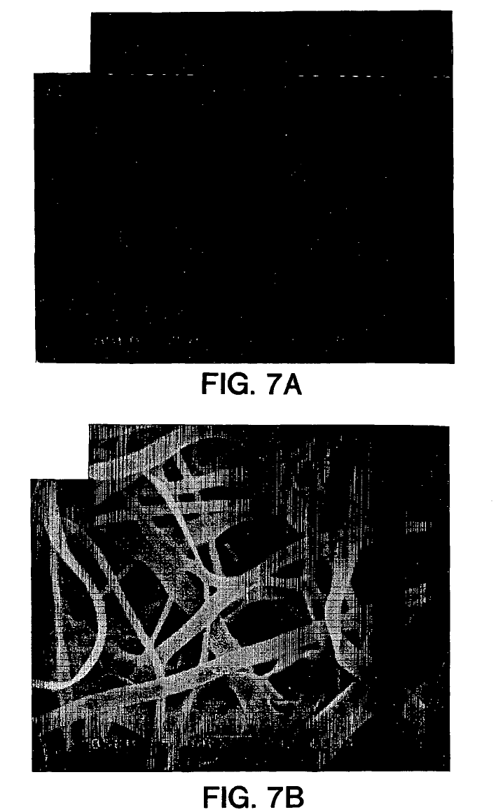

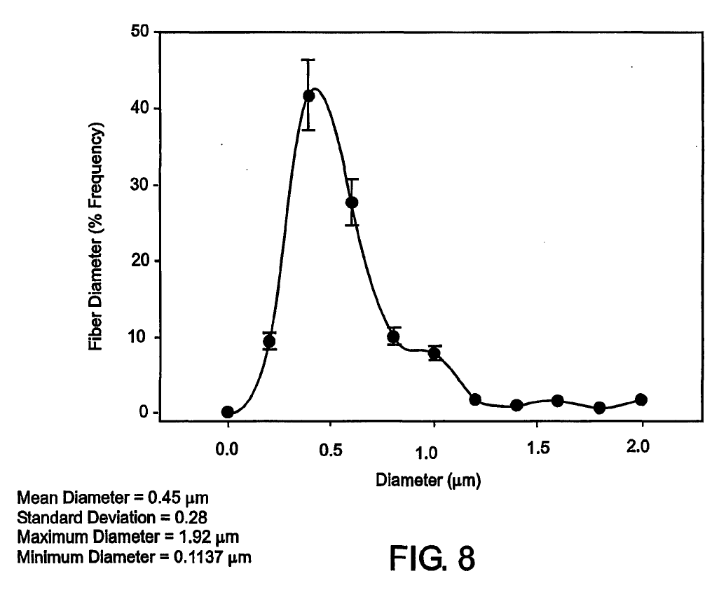

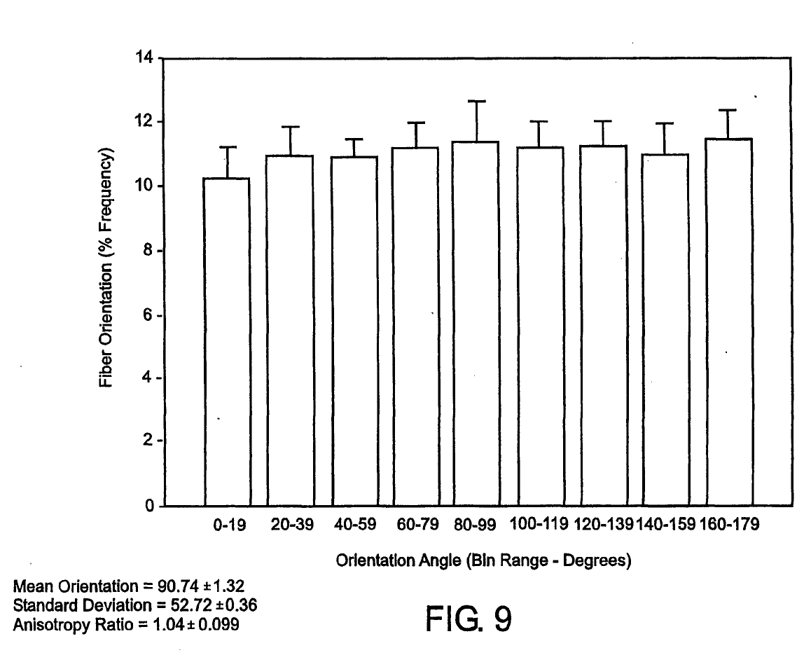

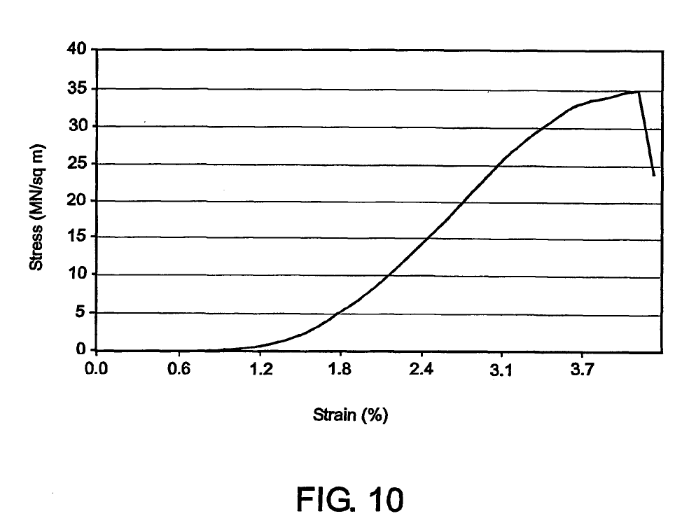

Non-woven fabrics were formed from fibers generated from a 15 wt % of polypeptide solution at a flow rate of 150 μl/ml (FIG. 7). As noted above, short time frame deposition studies had demonstrated that these conditions afforded the highest proportion of uniform, thin fibers with diameters of approximately 400 nm. Image analysis of the non-woven fabric revealed a unimodal distribution of fiber diameters with an observed average diameter of 450 nm (FIG. 8). The distribution of fiber orientation within this network followed a random pattern of fiber deposition with consequent generation of an isotropic nonwoven fabric (FIG. 9). Uniaxial stress-strain properties were characterized in dry non-woven fabrics, and a representative data set is illustrated in FIG. 10. The ultimate tensile strength of the sample was 35 MPa and the material modulus 1.8 GPa. Hydration and peptide crosslitking modulate these properties.

Urry et al. have demonstrated that non-conservative amino acid substitutions for Valine-4 can be performed without disruption of the β-spiral structure [Urry et al. (1985) supra; Thomas et al. (1987) supra; Urry et al (1989) supra; Chang et al. (1989) supra]. Thus, the incorporation of lysine in the four position of the pentapeptide and subsequent synthesis of the elastin-mimetic repeat sequence (Val-Pro-Gly-Val-Gly)₄(Val-Pro-Gly-Lys-Gly) (SEQ ID NO:4) permits spatially controlled chemical or enzymatic crosslinking [McMillan et al (2000) supra; Kagan et al. (1980) J. Biol. Chem. 255: 3656].

The genetic engineering of synthetic peptide polymers based upon a design derived from a native structural protein typically requires the incorporation of repetitive oligopeptide sequences that impart critical structural properties from the parent protein to the recombinant polypeptide. In the process, model systems for investigating the structure-function properties of the native protein are generated. Moreover, genetic engineering based strategies facilitate the alteration of peptide chain length, consensus repeat sequence, as well as the introduction of additional functional groups or oligopeptide units that modulate the biological, thermodynamic, and mechanical properties of the peptide polymer. For example, the appropriate choice of peptide sequence has led to the development of recombinant proteins that self-assemble into thermoreversible gels [Petka et al. (1998) Science 281:389-392], lyotropic smectic mesophases [Yu et al. (1997) Nature 389: 167-170], and lamellar crystallites [Krejchi et al. (1994) Science 265:1427-1432]. The uniformity of macromolecular structure achieved by this approach provides exquisite control over macroscopic polymer properties, including processability. The successful generation of fibers from elastin-mimetic peptide polymers has provided a unique opportunity to characterize the physiochemical and biological properties of single fibers as well as structures with higher levels of architectural order. In particular, the creation of fiber-reinforced composites based upon a careful choice of protein polymer types and network structures allows the engineering of improved human tissue constructs as well as completely synthetic artificial organs with enhanced clinical performance capabilities.

Elastin-mimetic protein fibers and fiber networks were produced by the electrospinning of an aqueous solution of a genetically engineered 81 kD peptide polymer based upon the repeat sequence (Val-Pro-Gly-Val-Gly)₄(Val-Pro-Gly-Lys-Gly) (repeats of SEQ ID NO:4). Fibers were generated at ambient temperature and pressure with optimal fiber formation observed with use of an 18 kV electric field and a 15 cm distance between the spinneret and plate collector. High resolution SEM and TEM confirmed that fiber morphology was primarily influenced by solution concentration and mass flow rate. Characteristically, fiber diameters varied between 200-3000 nm and three morphological patterns were noted: beaded fibers, thin filaments, and broad ribbon-like structures. At solution concentrations above 10 wt %, long uniform fibers were predominantly observed. Image analysis of non-woven fabrics produced from a solution concentration of 15 wt % revealed the isotropic orientation of individual fibers with an average fiber diameter of 450 nm. The ultimate tensile strength of these non-woven fabrics was 35 MPa and the material modulus was 1.8 GPa.

In its native form, elastin is present as a network of elastic fibers that are crosslinked through available lysine residues found in interspersed alanine-rich regions Robins, S. P. (1982) Methods Biochem. Anal. 28: 329-379; Miyoshi et al. (1976) J. Biochem. (Tokyo) 79: 1235-1243; Franzblau et al. (1977) Adv. Exp. Med. Biol. 79: 313-327; Akagawa, M. and Suyama, K. (2000) Connect. Tissue Res. 41: 131-141]. Characteristically, crosslinking occurs in the solid-state; that is, after cellular secretion of tropoelastin with local fiber deposition. In this fashion, the biostability of elastin is enhanced and its mechanical properties modulated. In contrast, crosslinking of synthetic elastin-mimetic protein polymers has been largely investigated in solution phase systems using either γ-irradiation [Zhang et al. (1989) J. Protein Chem. 8, 173-182], chemical, or enzymatic based approaches Sagan et al. (1980) J. Biol. Chein. 255: 3656-3659]. Urry et al. have demonstrated the feasibility of generating tubular hydrogels by γ-irradiation-mediated crosslinking [Urry et al. (1997) supra] and Welsh et al. have used glutaraldehyde to crosslink an elastin-mimetic protein flim [Welsh, E. R. and Tirrell, D. A. (2000) Biomacromolecules 1: 23-30; McMillan et al. (2000) Macromolecules 33: 4809-4821]. While these approaches provide a measure of control over the degree of crosslinking, the chemical nature, and the location of the crosslink are often ill-defined. Furthermore, none of these reaction schemes are appropriate for heterogeneous multicomponent systems in which there may be a need to control either the degree of crosslinking among individual constituents or otherwise to incorporate elements within the structure that may be adversely effected by unintended side reactions. In sunmary, the approaches that have been described to date have provided important insights into the physiochemical behavior of bioelastic systems under a variety of environmental conditions and have lead to novel processing strategies for creating elastomeric hydrogels for drug delivery and other applications. However, we believe that the generation of meaningful constructs for the engineering of human tissues and artificial organs will require the processing of elastomeric protein polymers into fibers and fabrics in which the protein polymer forms a crosslinked network. Thus, it is desirable to utilize a crosslinking strategy that is efficient in the solid-state, achieves precise control over the nature and degree of crosslinking, and facilitates spatial and temporal control over the reaction process.

We have optimized an electrospinning process to produce uniform nanofibers (d<1 μm) and non-woven fabrics of an elastin protein polymer poly((Val-Pro-Gly-Val-Gly)₄(Val-Pro-Gly-Lys-Gly))₃₉, 39 repeats of SEQ ID NO:4. Notably, amino acid substitution in the fourth position of the pentapeptide does not affect the formation of a β-spiral [Huang (2000) Macromolecules 33: 2989; Thomas et al. (1987) Biopolymers 26: 921-934; Chang et al. (1989) J. Biomolec. Struct. Dyn. 6: 851-858; Urry et al. (1989) Biopolymers 28: 819-833], which is critical for the biomechanical behavior of elastin analogues. The incorporated lysine group at position 24 within the repeat of SEQ ID NO:4 (Lys-24) provides an amino functionality that can be conveniently utilized for polymer crossliknlg. Indeed, McMillan et al. have recently reported the formation of structurally well-defined crosslinked elastin-mimetic hydrogels using an N-hydroxysuccinimide ester of a bifunctional carboxylic acid, specifically, disuccinimidyl suberate, as crosslinker of available amino groups in the solution phase [McMillan et al. (1999) Macromolecules 32: 9067-9070]. Herein we describe the incorporation of functional groups into the protein polymer backbone that facilitate site-specific solid-state photocrosslinking using either UV or visible light active photoinitiators. Significantly, this approach provides for both spatial and temporal control over the crosslinking reaction. The generation of crosslinked elastin-mimetic fibers and films is reported, and mechanical properties characterized.

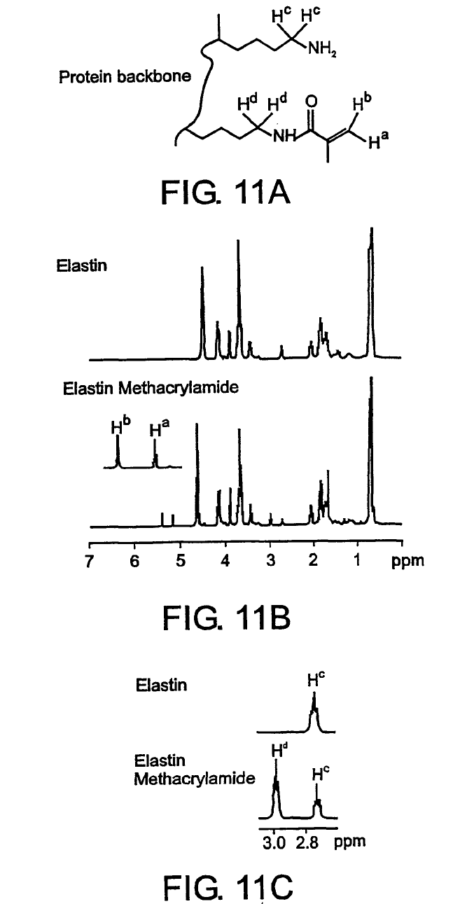

The synthesis of acrylate-modified elastin-mimetic polypentapeptide has been accomplished. ¹H NMR spectra of the elastin-mimetic protein polymer and its acrylate-modified analogue (AME) recorded at room temperature in D₂O are shown in FIG. 11A-11B. The spectrum of the modified material expanded between 5.0 and 5.7 ppm is shown in the inset in FIG. 11A. The spectrum clearly indicates the incorporation of the double bonds through peaks at 5.3 (H^{a}) and 5.6 ppm (H^{b}). FIG. 11B is the expanded version of the spectra, between 2.6 and 3.1 ppm. Acrylate modification results in about 0.25 ppm (H^{d}) downfield shift for the methylene protons alpha to the amino group (H^{c}). This shift can be used to directly calculate the degree of functionalization (DOF). The ratio of the integrated intensity of the 3 ppm peak to the sum of the integrated intensities of the 3 and 2.75 ppm peaks defmes the DOF. Additionally, IR spectroscopy can be used to evaluate DOF. The NH₂ band at 3500 cm−1 decreases with functionalization.

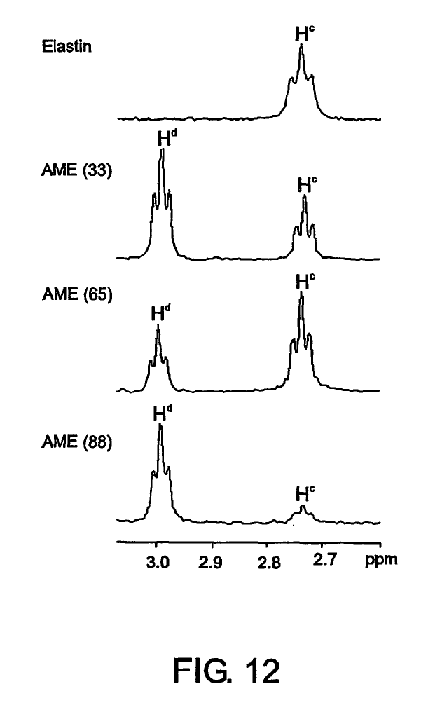

The DOF can be varied by changing the molar reactant ratio of the methacryloyl anhydride to the amino groups in the peptide polymer. FIG. 12 illustrates the variation in the DOF that can be achieved, as demonstrated by changes in peak intensities in the ¹H NMR spectrum. In the unmodified material the 3 ppm peak is absent. As the molar ratio of the anhydride is increased, the intensity of the 3 ppm peak increases at the expense of the 2.75 ppm peak, indicating an increased degree of functionalization. The DOF can be varied from 33% to 88% by changing the feed ratio from 1:1 to 3:1. Thus, using the same reaction scheme a wide variety of AMEs can be produced, resulting in materials having a wide range of mechanical properties (subsequent to crosslinking). For the remainder of the discussion, the AMEs will be represented by their respective DOF in brackets.

The inverse temperature transition (Tₜ) of elastin-mimetic and acrylate-modified analogues has been analyzed. Mutual compatibility of a polymer and a solvent has been extensively studied and is often critical for processing needs. Urry et. al. have shown that a family of protein polymers based on the VPGVG (SEQ ID NO:2) repeat undergo an inverse temperature transition [Urry et al. (1985) Biopolymers 24: 2345-56]. On increasing the temperature from below to above the transition temperature, the proteins were found to undergo molecular assembly by protein folding with phase separation. For example, poly(GVGVP) is miscible with water in all proportions below 25° C., but on increasing the temperature above 25° C., the solution becomes turbid with complete phase separation. Thus, temperature-dependent turbidimetry measurements can be used to quantify the inverse transition temperature.

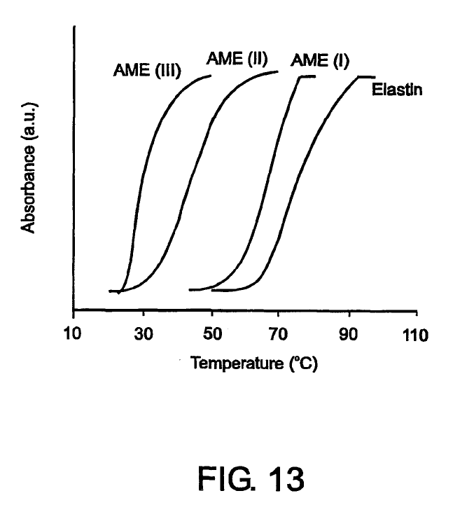

Results of turbidimetry measurements on elastin and acrylate-modified elastin materials in ddH₂O are shown in FIG. 13. The temperature corresponding to one-half maximal turbidity can be considered the Tₜ. The data demonstrate that acrylate-modification causes a reduction in the inverse temperature transition with 88% conversion of the amino groups, producing a reduction in the transition temperature by about 50° C. (Tₜ^{˜}23° C.). This reduction is consistent with the Tₜ-based hydrophobicity scale developed by Urry et. al. [Urry et al. (1985) Biopolymers 24: 2345-56]. Their investigations established that an increase in the hydrophobicity of model protein polymers, as a result of substitution at the fourth position, is thermodynamically offset with a decrease in the transition temperature. The measurement of Tₜ assumes particular importance in our studies, because the processing temperature for fiber formation is dictated by Tₜ. The phase separation phenomenon occurring above Tₜ precludes fiber formation. For example, in principle, fibers can be spun from aqueous solutions of AME(33) and AME(65) at room temperature, which is well below the Tₜ. However, the onset of turbidity begins close to room temperature for AME(88). Thus, fibers from 10-15 wt % AME(88) in water (pH 7) required cold room spinning (at about 5° C).

The crosslinking of the acrylate moiety is mediated through a photoinitiator. The mechanism for photocrosslinking has been extensively reviewed [Eaton, D. F. (1986)Advances in Photochemistry 13: 427487]. Because fiber spinning is conducted from aqueous solutions, water-soluble photoinitiators are desirable. Two photoinitiators were investigated: eosin Y/triethanolamine/vinyl pyrillidone system and IRGACURE 2959 (Irgacure 2959 is 1-[4-hydroxyethoxy)-pheny]-2-hydroxy-2-methyl-1-propane-1-one; Ciba Geigy), both of which have been used as photoinitiators in water-based systems [Van Den Bulcke et al. (2000) Biomacromolecules 1: 31; Cruise et al. (1998) Biotechnol. Bioeng. 57: 655-65]. While both photoinitiators were tested for crosslinking efficiency, the reported mechanical results are for the EY-based systems. Other photoinitiators which function under mild conditions of temperature and without producing a level of free radicals which lead to protein damage can be used, and the selection of light wavelength and temperature for a particular combination of wavelength and functional group are well understood in the art.

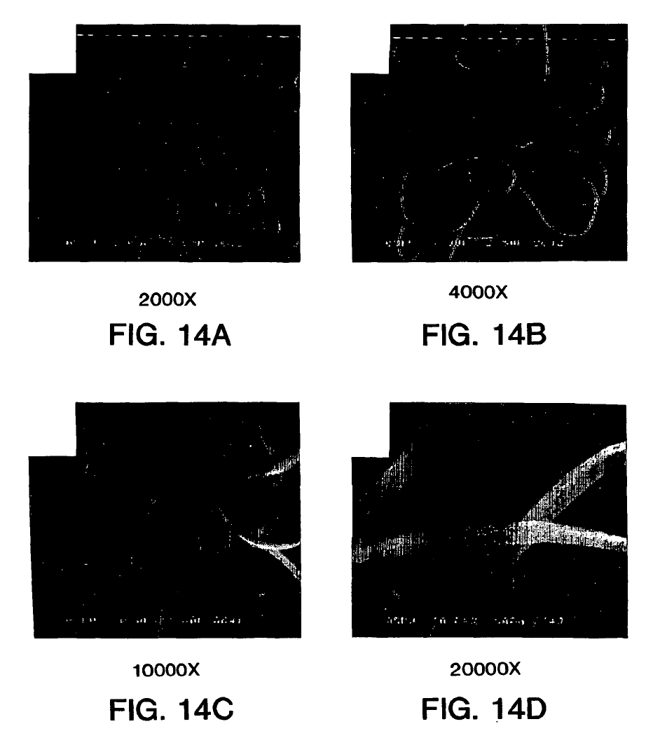

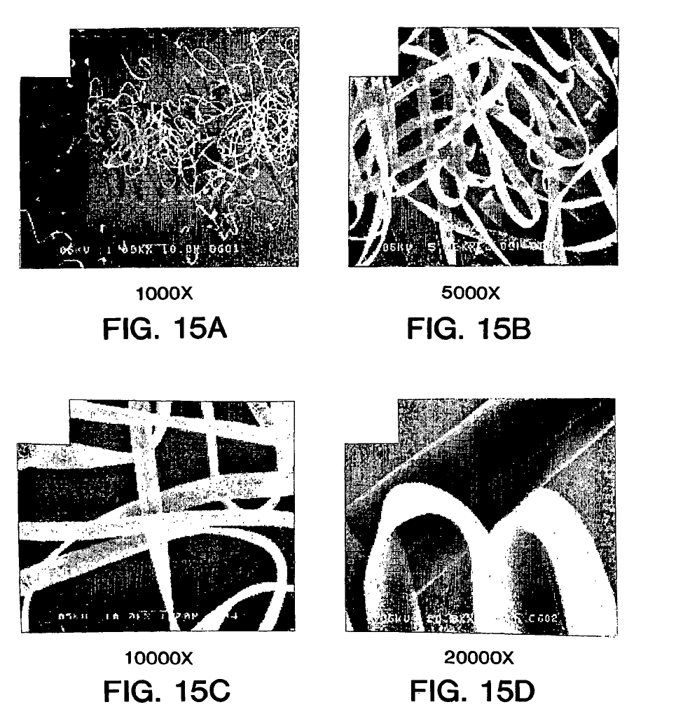

FIGS. 14 and 15 show SEM micrographs of the fibers produced from 10 and 15 wt % solutions at a flow rate of 50 μl/min, as described in Example 4. In both cases, long uniform fibers were produced. In fibers spun from the 10 wt % solution, average diameter ranged between 300-500 nm with occasional triangle shaped bifurcation points noted. In contrast, fibers spun from the 15 wt % solution were exhibited a flat or ribbon type morphology with the absence of triangular bifurcation points. In comparison to our previous investigation of unmodified elastin-mimetic fibers, neither acrylate-modification nor the addition of photoinitiator to the spinning solution had any appreciable effect on fiber morphology.

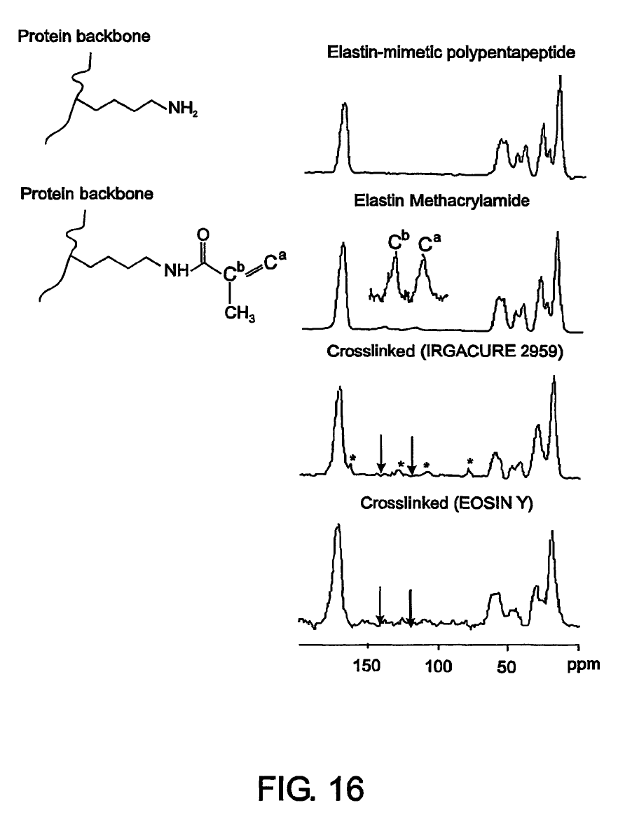

Solubility in water was used as a simple test to determine the efficiency of crosslinking. While elastin samples that did not contain photoinitiator dissolved completely in water, those containing Eosin Y or Irgacure were insoluble in water. The extent and nature of crosslinking was more precisely determined using ¹³C solid-state NMR. Owing to its inherent structural specificity, solid-state NMR has been extensively used in the past to study chemical changes ensuing after crosslinkjng [O'Donnell, J. H. and Whittaker, A. K. (1992) Radiat. Phys. Chem. 36: 209; O'Donnell, J. H. and Whittaker, A. K. (1992) J. Polym. Chem. Ed. 30: 185]. FIG. 16 shows the ¹³C solid-state MAS/TOSS NMR spectra of elastin, elastin methacrylamide, and crosslinked elastin methacrylamide. The addition of double bonds to elastin via methacryloylation is clearly evidenced by the appearance of peaks C^{a} and C^{b} in the spectrum of elastin methacrylamide. For the sake of clarity, the double bond region is magnified and shown as an inset along with the elastin methacrylamide spectrum. The spectra for samples crosslinked either by Eosin Y or Irgacure show the complete disappearance of the double bonds and appearance of new peaks corresponding to the photoinitiator labeled as “*”. For the irradiation time employed, solid-state NMR spectra confirm complete crosslinking. No evidence of crosslinking was detected in the absence of photoinitiator.

The dependence of protein crosslinking on irradiation time was investigated in detail for the 15 wt % AME(88)/EY system. Samples were irradiated for up to 60 minutes, lyophilized in the dark, and stored at −20° C. in brown bottles to avoid light exposure prior to solid-state NMR analysis. The double bond region (peaks C^{a} and C^{b}) were integrated for each sample and the integrated double bond areas were normalized with respect to that of the unirradiated sample. FIG. 18 shows the degree of crosslinkling as a function of irradiation time. After an hour of visible light irradiation, the crosslinking process was complete. Increased variability of experimental data obtained at higher degrees of crosslinking was attributed to decreasing signal to noise ratio in the integrated region.

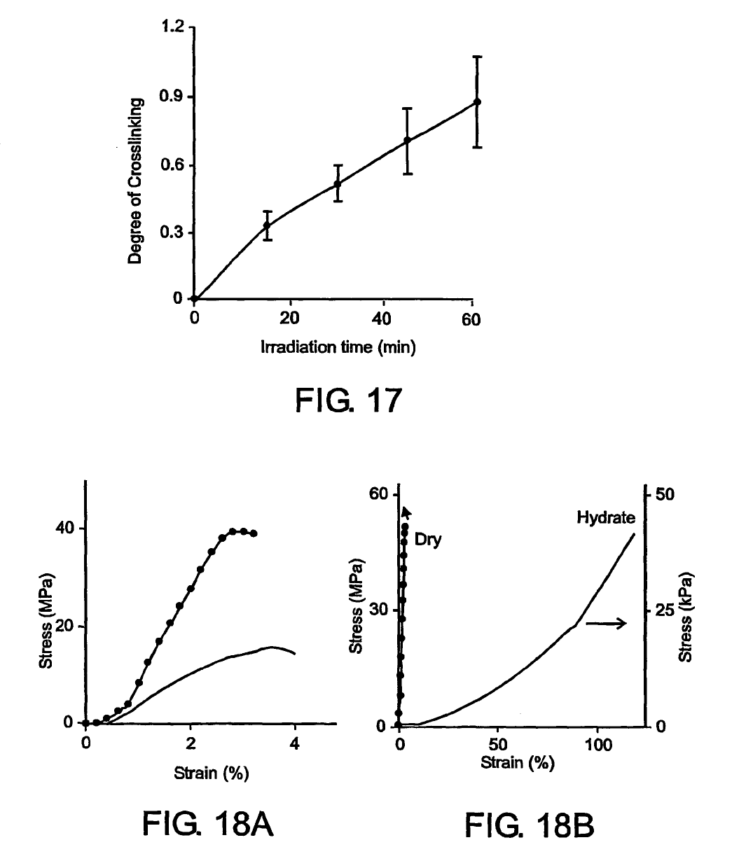

The crosslinked and the uncrosslinked samples were subject to tensile testing to determine the mechanical effect of crosslinking. FIG. 17 shows representative stress-strain curves of the two samples. The uncrosslinked material (elastin methacrylamide) had a modulus of 0.7±0.15 GPa and a tensile strength of 16.2±6.3 MPa, while the crosslinked sample had a modulus of 1.8±0.4 GPa and a tensile strength of 43.3±5.2 MPa. As anticipated, crosslinking enhanced both Young's modulus and tensile strength with a concomitant decrease in the strain to failure from 3.9±0.2% to 2.1±0.35%. In the dry state, crosslinking renders the sample stiffer and more brittle as compared to the uncrosslinked sample. FIG. 18 shows the comparative stress-strain behavior of dry and hydrated crosslinked samples of AME(65). Clearly rubber elastic behavior ensues subsequent to hydration. The hydrated sample had an average modulus of 0.45±0.08 MPa and a strain to failure of 105±8%. Notably, the degree of crosslinking estimated from ideal rubber elasticity theory compares well with that obtained from solid-state NMR.

45 min of irradiation→calibration curve→75%×0.65

In summary, post processing solid-state crosslinking of elastin-mimetic fibers was investigated. Through available lysine residues, an elastin-mimetic protein polymer was modified to incorporate an acrylate moiety. The degree of acrylate functionalization could be varied by changing the reactant ratio of anhydride to elastin. The AME's were found to have lower inverse transition temperature than the unmodified sample. This was attributed to the increase in the hydrophobicity of the sample with the introduction of the acrylate group. The inverse transition temperature in turn dictated the temperature for fiber formation. Fibers and fabric samples of AME were prepared by electrospinning at appropriate temperatures. Depending upon the concentration of the solution, fibers with diameter ranging from 300 nm to 1.5 μm were produced. The fibers were subsequently crosslinked using photoirradiation.

The insolubility of the resulting sample in water indicated a high degree of crosslinking with complete crosslinking confirmed by ¹³C solid-state NMR. The mechanical properties of the samples were commensurate with that expected, in that modulus and tensile strength increased upon crosslinking. Moreover, hydrated samples displayed rubber-like behavior with high extensibility. Thus acrylate modification provides a viable route for solid-state crosslinking of elastin-mimetic protein-based materials. With the production of crosslinked elastin-mimetic fabrics, the capacity to engineer tissue-like constructs has been significantly enhanced.

Collagen is a biodegradable, biocompatible, and non-immunogenic structural protein, which makes it a suitable compound for a variety of biomedical applications. Examples include collagen use in cosmetic and urological surgery as an injectable compound for tissue augmentation, in orthopedic surgery as an implantable matrix to promote bone growth, and in plastic and general surgery as a topical agent for the treatment of both chronic non-healing wounds and burn injuries or as a template for tissue regeneration. The most abundant form of collagen isolated from adult connective tissues, such as skin, tendon, and bone, is type I collagen. Characteristically, it is composed of two α1(I) chains and one α2(I) chain, each slightly more than 1000 amino acids long, that are organized as a triple helix and stabilized primarily by hydrogen bonds. A single molecule of type I collagen has a molecular mass of 285 kD, a width of ^{˜}14 Å, and a length of ^{˜}3000 Å. As a biomaterial, collagen has been predominantly used after processing into a dry powder or slurry, a hydrogel after solution phase crosslliing, or as a porous matrix with or without the addition of other components after freeze-drying. However, in native connective tissues, type I collagen molecules form fibrillar elements, twenty to several hundred nanometers in diameter that are organized into protein networks of varying architecture. Functionally, collagen fiber networks act to resist high strain deformation and in the process transmit forces, dissipate energy, and prevent premature tissue mechanical failure. These fiber networks constitute the principle structural elements of a variety of acellular bioprosthetic tissue substitutes, such as porcine heart valves and bovine artery heterografts, as well as other tissue derived matrices, including porcine subintestinal submucosa and bovine pericardium. The versatility of collagen as a scaffold for tissue engineering applications is significantly enhanced when used as a native protein network. To date, attempts to reformulate tissue extracted native collagen into protein fiber networks and fabrics have been limited.

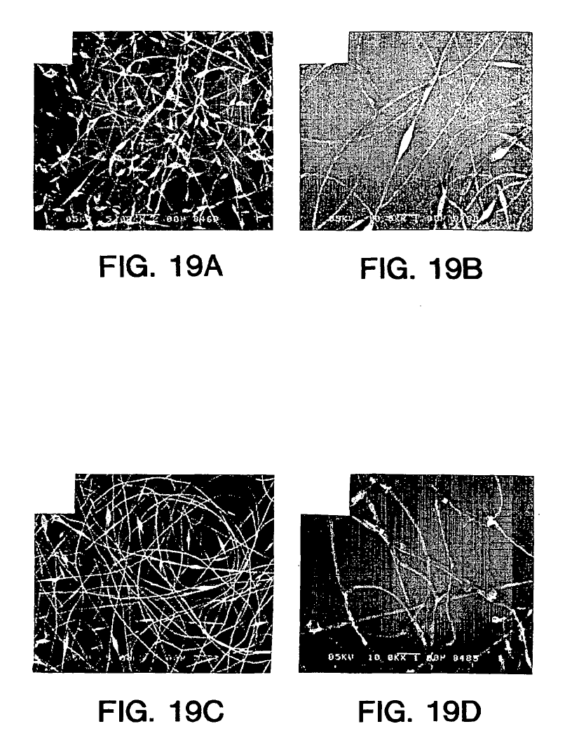

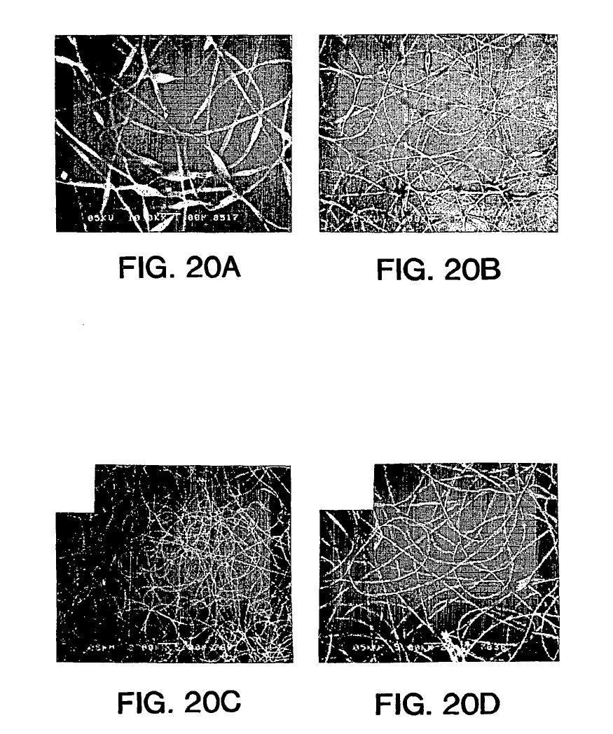

PEO is non-toxic, chemically stable in acidic solution, and when of sufficient molecular weight is capable of forming electrospun fibers. Significantly, fibers could not be formed from a 1-2 wt % pure collagen in aqueous solution, but were observed after the addition of PEO. High resolution SEM demonstrated unique morphological features as a fumction of the weight ratio of PEO to collagen, as well as solution conductivity and flow rate. Solution viscosity as related to PEO content and the effect of sodium chloride concentration on solution conductivity are summarized in Tables I and II. The effect of the collagen:PEO ratio on tensile strength and modulus is shown in Table III. Increasing the concentration of PEO increased the yield of uniform fibers, while reducing bead formation. Beads predominated at collagen-PEO weight ratios of 10:1 and 5:1, with only rare beads noted at a ratio of 1:1 and none observed at a collagen-PEO ratio of 1:2. Under this condition, uniform fibers were produced with diameters ranging between 50-150 nm. The formation of beads has been attributed to jet instability, which is believed reduced upon increasing solution viscosity due to addition of high molecular weight PEO. Likewise, solution conductivity was also found to influence fiber formation. When an electric field is applied to an electrolyte-containing aqueous polymer solution, field induced ion movement carries the solution along by an additional viscous drag force. This phenomenon enhances jet stability and, as a consequence, reduces bead formation. While fiber uniformity increased with the addition of sodium chloride, crystal formation was observed at high salt concentrations (FIGS. 19A-19F). Finally, we observed that small changes in flow rate had a marked impact on collagen/PEO fiber morphology. Below 100 μL/min, bead formation was increasingly pronounced, while at flow rates above this level, the limited volatility of the polymer solution prevented adequate fiber drying under conditions of ambient temperature and pressure. TEM imaging confirmed HRSEM analysis and did not reveal any additional internal structural features. See FIGS. 19A-19D.

We determined the microphase structure of collagen-PEO blends by solid-state NMR. The dipolar magnetization transfer method depends on creating a magnetization gradient across the sample and then monitoring the time it takes for spin equilibration to occur following the creation of the gradient. This equilibration time will depend upon the domain sizes in the system and the spin diffusion coefficients associated with each phase. If the diffusion coefficients of different regions and the dimensionality of the diffusion process are known a priori, then the domain sizes in the system can be extracted by fitting a simulated diffusion profile to the experimental data. The simulated profile can be obtained by numerically solving the diffusion equation with appropriate initial and boundary conditions. It is also clear that if diffusivities are isotropic, then only the minimum domain distances will be probed since the shortest path for the establishment of spin equilibration lies along this direction (D. L. Vanderhart (1990) Makromol. Chem., Macromol. Symp. 34: 125). The domain distances that can be observed using spin diffusion range from about 2 nm to 100 nm. The upper bound for the observable domain distance will depend upon the time in which it is possible to observe the magnetization polarization. This is governed by the spin lattice relaxation of protons in the sample. Though there is a limitation on the maximum domain distance observable, there are many multiphase polymer systems that exhibit domains of the order that can be investigated by the spin diffusion technique. For example, long periods in semicrystalline polymers and domain sizes in many block copolymers fall well within the range of detection by spin diffusion [K. J. Packer et al. (1984) J. Polym. Sci.: Polym. Phys. 22: 589; Kimura et al (1992) Polymer 33: 493; Cai et al. (1993) Polymer 34: 267].

Collagen fibers were spun and cross linked into fibers using collagen dissolved in fluorinated solvent or dissolved in a water-fluorinated solvent mixture. Although collagen fibers could not be produced from 1-2 wt % solutions in water, either changing the temperature or altering the solvent system can produce pure collagen fibers. By increasing the temperature to 36° C. formation of collagen fibers were noted. Fluorinated alcohol/water mixtures can serve as alternate solvents systems to produce collagen fibers. For example production of collagen fibers in the 300-800 nm diameter range could be achieved from spinning 10-15 wt % of collagen in such fluorinated solvents. The solvent compositions used were (a) 10 mole % trirluoroethanol (TFE)/90 mole % water and (b) 10 mole % hexafluoroisopropanol (HFIP)/90 mole % water. Collagen spinning can also be effected from combinations of water with other fluorinated alcohols.

The most important step in the spin diffusion experiment is the creation of the magnetization gradient. The magnetization gradient is usually realized by using an appropriate selection sequence. For multiphase systems that display a large gradient in mobility between constituent phases, a simple filter based on spin-spin relaxation (T₂) can be used to selectively retain the magnetization of the more mobile phase. For example, consider a blend of two components A and B with disparately different T₂'s. If A has a T₂ of 100 μs and B has a T₂ of 1 ms, then by applying a T₂ filter of 700 μs, one can destroy the magnetization in A and selectively retain the magnetization in B, thereby creating a magnetization gradient. This is the basis of the Goldman-Shen experiment and many variations thereof that have been used to probe domain distances in polymer blends [U.S. Pat. No. 5,911,942 (1999)]. For the system under consideration, the two components, PEO and collagen, have very different T_{g}'s (T_{g,Collagen} ^{˜}125° C. and T_{g,PEO}^{˜}−65° C.) and are hence amenable for investigation via the mobility-based approach. The simple T₂ filter was replaced with a dipolar filter selection sequence. The dipolar filter was selected since it provides greater tunability and has been presented as a technique that can overcome spectral distortions produced by multi-quantum effects that are prevalent at short spin difffusion times [Egger et al. (1992) J. Appl. Poly. Sci. 44: 289].

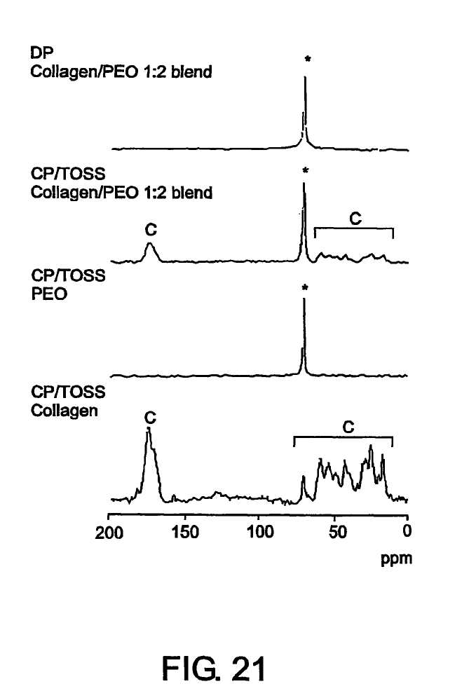

FIG. 21 shows the CP/MAS/TOSS and DP/MAS spectra of collagen, PEO and an electrospun fabric of 1:2 collagen/PEO. The CP spectrum of the collagen/PEO fabric appears to be a simple superposition of the CP spectra of collagen and PEO in that it shows the resonances from both collagen and PEO. The DP spectra typically discriminate against the more rigid regions in the sample. The DP spectrum of collagen (not shown) indicates that it is very rigid at the measuring temperature (24° C.). The reported glass transition of dry collagen is approximately 125° C. rendering collagen rigid at room temperature. The DP spectrum of PEO (not shown) indicates that PEO is highly mobile at room temperature (T_{g}, PEO −65° C.). In the case of the collagen/PEO fabric the DP spectrum clearly shows that PEO is highly mobile when compared to collagen. This vast difference in mobility between collagen and PEO can be exploited in terms of a ¹H dipolar magnetization transfer experiment to provide information about the domain sizes in the fabric.

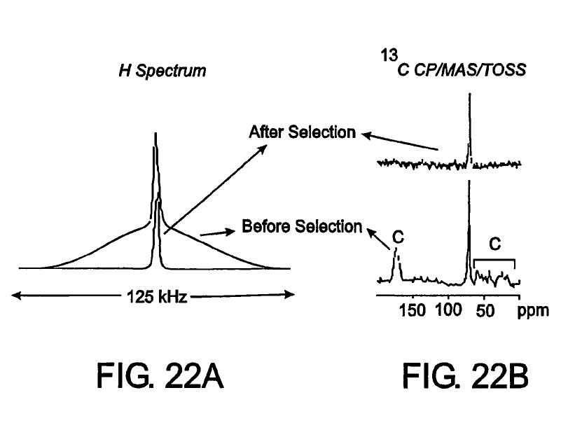

The most important step in the spin diffusion experiment is the establishment of the initial magnetization gradient. FIG. 22A shows the ¹H spectra of an electrospun 1:2 collagen-PEO fabric before and after the application of the dipolar filter. The spectrum acquired before the application of the filter is a superposition of a broad (rigid) and a narrow (mobile) component. The spectrum acquired after the application of the filter shows only the narrow component indicating that the filter has destroyed the magnetization associated with the rigid regions. In order to ascertain the chemical identity of the regions selected after the application of the filter, a CP/MAS sequence was appended to the spin diffusion sequence as described in the experimental section. The ¹³C CP/MAS spectra are shown in FIG. 22B. It is clear from the CP/MAS spectra that the filter selectively retains magnetization in the more mobile PEO regions while destroying the magnetization in the more rigid collagen regions. Thus the chosen filter parameters result in an efficient establishment of magnetization gradient in the sample. Similar results were obtained with a 1:1 fabric sample.

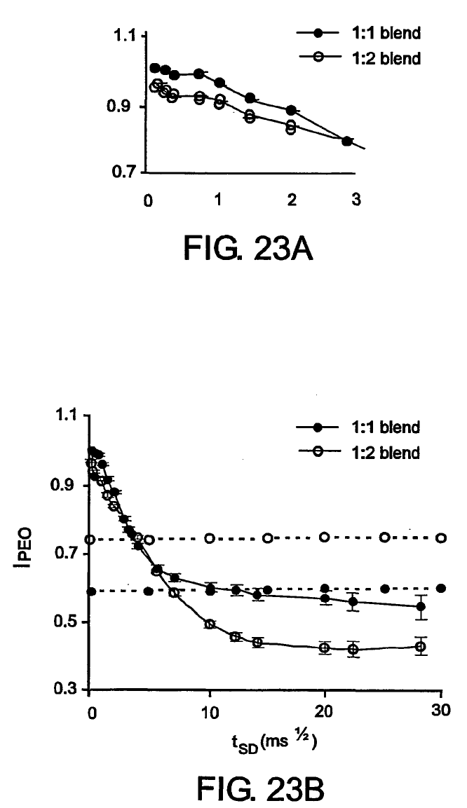

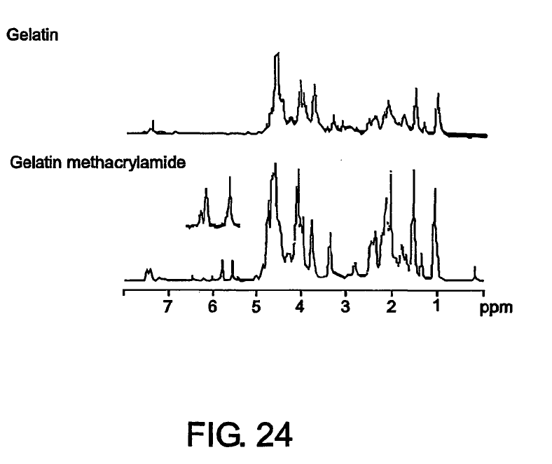

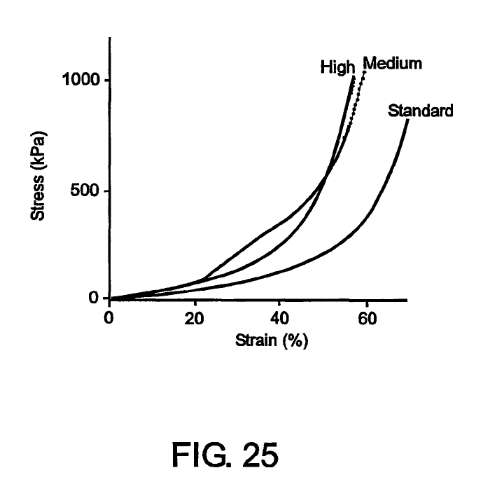

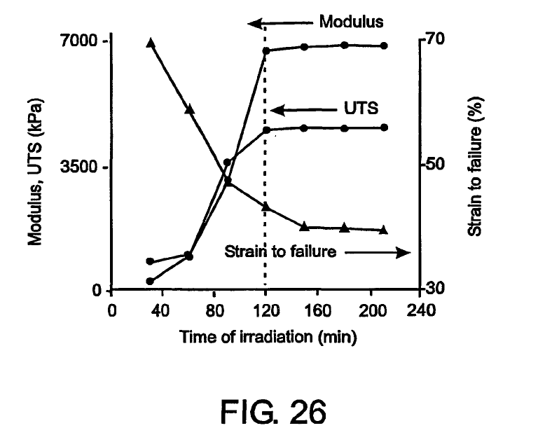

The spin diffusion data for 1:1 and 1:2 fabric blends are shown in FIG. 23. The inset in FIG. 7 shows the initial time data. From the inset it is clear that the magnetization in the source phase contacts the sink phase slower in the 1:1 blend than in the 1:2 blend (the initial portion of the curve for the 1:1 blend is sigmoidal while it is linear for the 1:2 blend). This is indicative of the presence of an interface in the 1:1 blend while there is very little or no interface in the 1:2 blend. The formation of an interface in the case of the 1:1 blend is not surprising since the potential exists for hydrogen bonding between the ether oxygen of the PEO and protons of the amino group in collagen. The presence of associative interactions has known to produce phase mixing in polymer blends. Thus, mere visual inspection of the initial time data suggests that mechanically stronger fabrics could be produced from the 1:1 blend due to the presence of an interface.

The dotted lines in the figure represent the theoretical (expected) end value of spin diffusion. As expected the theoretical end value for the 1:2 blend (0.74) is greater than the 1:1 blend (0.59) since more of the mobile phase is available for selection in the 1:2 blend. These theoretical values are calculated assuming that the entire PEO phase is available for selection. However it must be borne in mind that PEO is capable of crystallizing in the blend. Crystallization of PEO accounts for the difference between the observed and expected end values of spin diffusion. Crystallization of the source phase results in the lowering of the expected end value. From the observed end values it becomes evident that the 1:2 blend has a higher degree of crystallinity than the 1:1 blend. Indeed DSC experiments conducted on the electrospun fabrics show that the degree of crystallinity in the 1:2 blend is around 36% while that in the 1:1 blend is 12%. From these data it can be surmised that crystallization induced phase separation occurs in the 1:2 blend precluding the formation of a substantial interface.

Non-woven fabrics were formed from collagen/PEO fibers generated from a 2 wt % of type I collagen-PEO solution at a flow rate of 100 μL/mL and uniaxial stress-strain properties characterized in the dry state. A pure PEO fabric sample had the lowest tensile strength of 90 KPa and a modulus of 7 MPa. The tensile strength and modulus of a 1:2 collagen-PEO blend were 270 KPa and 8 MPa, respectively. Maximum values were observed for the 1:1 blend with a tensile strength of 370 KPa and a modulus of 12 MPa. NMR analysis, as reported above, suggested that the superior mechanical properties, observed for collagen-PEO blends of weight ratio 1:1, were due to the maximization of intermolecular interactions between the PEO and collagen components.

Type I collagen-PEO fibers and non-woven fiber networks were produced by the electrospinning of a weak acid solution of lyophilized collagen purified from rat tail tendon. Fibers were generated at ambient temperature and pressure with optimal fiber formation observed with use of an 18 kV electric field and a 15-cm distance between the spinneret and plate collector. Fiber morphology was influenced by solution viscosity, conductivity, and flow rate. As determined by high-resolution SEM and TEM, highly uniform fibers with a diameter range of 100-150 nm were produced from a 2 wt % solution of collagen-PEO (1:1 weight ratio, 34 mM NaCl) at a flow rate of 100 μL/min. The ultimate tensile strength of the resulting non-woven fabric was 370 KPa with an elastic modulus of 12 MPa.

Efforts to process collagen into man-made fibers have been limited, and generally approaches to date have been confined to wet spinning methodologies. Wet spinning involves the extrusion of a protein solution through a spinneret into an acid-salt coagulating bath, which usually contains aqueous ammonium sulfate, acetic acid, isopropanol, or acetone. Further treatments in ethanol and acetone solutions are often required for fiber dehydration. Limitations of this approach include the use of biologically toxic solvent systems that preclude the fabrication in real time of hybrid protein-cell constructs, as well as conditions which likely induce significant conformational changes in native protein structure, including protein denaturation. Finally, wet spinning is largely confmed to the generation of fibers that range from tens to hundreds of microns in diameter. In contrast, the process outlined herein provides a convenient, non-toxic, non-denaturing approach for the generation collagen-containing nanofibers and non-woven fabrics that have applications in medical and veterinary prostheses, artificial organs, wound healing and tissue engineering, and as hemostatic agents.

Bioconjugate techniques involving the manipulation of various amino acid side chain residues have become commonplace in modern biochemistry. Our strategy involved the covalent attachment of an acrylate moiety to lysine and hydroxylysine side chains. Via nucleophilic attack, methacryloyl anhydride was used to acylate the Σ-amino group of the lysine and hydroxylysine residues. Once modified, the gelatin was crosslinked using eosin-Y/triethanolamine/1-vinyl-2-pyrrolidinone free radical photoinitiation [Cruise et al. (1998) supra].

By using the technique of electrospinning [Reneker, (1996; supra; Huang (2000) supra], we formed fibers with diameters in the nanometer range (<1 μm). These sizes have been reported to closely approximate fiber morphology through out much of the extracellular matrix. [Birk, 1991 #10] By spinning acrylate-modified gelatin into various constructs (i.e. sheets and tubes) and subsequent crosslinking, an integrated protein matrix structure can be formed in an expeditious and precise manner.

FIG. 24 shows the ¹H NMR spectra of gelatin and acrylate modified gelatin in D₂O recorded at 45° C. Incorporation of double bonds in the system can be inferred from the presence of two new peaks in the spectrum of gelatin methacrylamide. Integrating the double bond region provides a measure of the degree of functionalization (DOF). DOF was defined as the ratio of the amino moieties functionalized to the total number of amino moieties in the gelatin prior to functionalization. In this case the DOF was calculated be around 73%. It has already been shown by Van de Bulcke et. al (vide infra) that the DOF could be varied by changing the methacryloyl anhydride to the gelatin ratio. A range of gelatin-based materials with different DOF's can be obtained using this reaction.

Acrylate functionalized gelatin was processed into films to examine the effect of crosslinking on mechanical properties. The film samples for the study were prepared according to the procedures outlined hereinbelow. The effects of photoinitiator concentration and irradiation time on the crosslinking process were investigated. The results of these studies could then be used to optimize the crosslinking conditions during fiber production. Crosslinning optimization studies were performed on film samples since they were much easier to process than the fiber samples.

For the first study three samples were prepared. The concentration of gelatin methacrylamide was the same in each of the three samples while the photoinitiator concentration was varied from standard to high. The solvent was allowed to evaporate and the filn samples were formed. The dry films were exposed to an hour of irradiation using a Dyna-Lume visible light source at 70 mW/cm². The sample was cut into strips for tensile testing. The studies were then performed on the hydrated samples. Eight samples were tested for each photoinitiator concentration.

FIG. 25 shows the stress-strain data for crosslinked gelatin methacrylamide films with varying photoinitiator concentration. Going from the standard to medium photoinitiator concentration provides a moderate increase in modulus while significantly decreasing the strain to failure. However, going from medium to high photoinitiator concentrations decreased the modulus slightly. Hubell et. al have previously reported that the photopolymerization process can be adversely affected by increasing the concentration of TEA. Increased TEA concentrations are believed to lead to more radicals being generated, and these radicals in turn can react and terminate the process. However, increasing VP concentration negates the effect of increasing TEA concentration by providing more sites where the photo-generated radicals can attack. The potentially negative effect of increased TEA concentration is overcome by increased VP concentration at medium photoinitiator concentration. However at the high concentration conditions, the TEA effect dominates, leading to a decrease in the modulus. In going from standard to medium concentration the gain in the modulus was not appreciable. Moreover, it is desirable to use as little of the photoinitiator as possible to achieve the desired level of crosslinking. Accordingly, it was decided to use the standard concentration for the remainder of the study.

To study the effect of irradiation time on the degree of crosslinking, seven 5 wt % gelatin methacrylamide solution samples were prepared. Each sample was irradiated by a visible light source for varying lengths of time starting from ½ hour to 3 ½ hours. FIG. 26 shows the ultimate tensile strength, modulus, and strain to failure of hydrated samples as a function of irradiation time. The ultimate tensile strength and the modulus increased with increasing irradiation times while the strain to failure decreased. No significant change in the mechanical properties is observed past two hours of irradiation. The mechanical data indicate that two hours of visible light irradiation is sufficient to complete the crosslinking reaction in the conditions described herein.

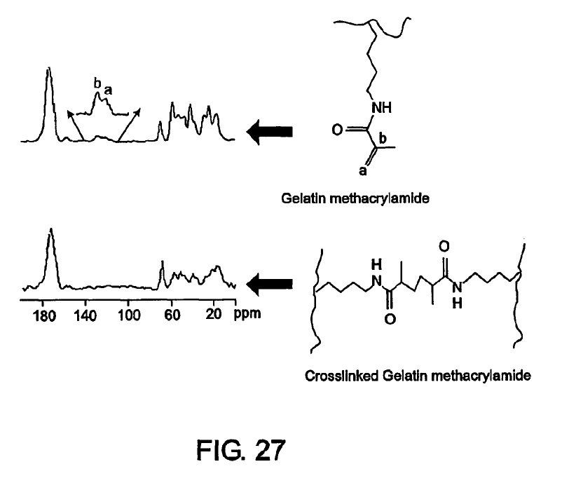

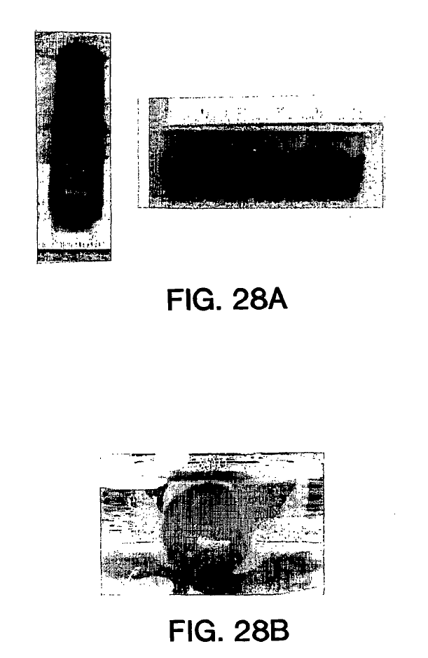

To ascertain whether the reaction had gone to completion, ¹³C solid-state NMR spectroscopy was conducted on the samples from the same batch that was used for used for tensile testing. The crosslinked sample was irradiated for two hours. The ¹³C CP/MAS/TOSS spectra of gelatin methacrylamide and crosslinked gelatin methacrylamide is shown in FIG. 27. The gelatin methacrylamide spectrum shows two resonances due to the double bond carbons. However, in the spectrum of the crosslinked material these resonances have completely disappeared, indicating that the crosslinking reaction has gone to completion. When the NMR data is taken in conjunction with the mechanical data, it conclusively shows that crosslinking is complete for the given DOF in two hours. Although time consuming, solid-state NMR can be used to map the degree of crosslinking as a function of irradiation time. An approximate degree of crosslinking can be calculated using the rubber elasticity theory. According to the theory the modulus is given by

E=3 ρRT/M_{C}

where E is the modulus, ρ is the density, R the gas constant, T the temperature, and M_{C} the average molecular weight between crosslinks. M_{C} can be calculated from the measured modulus (from the tensile testing experiments) and this quantity is inversely proportional to the degree of crosslinking. Thus degree of crosslinking is directly proportional to the modulus of the material. Thus modulus measurements can also be used to provide a rough estimate of the degree of crosslinking. Natural elastin has a modulus of abut 0.9 to about 1.1 MP*. Calculations show that about 50 to about 75% cross linling is needed in the crosslinked modified elastin or elastin mimetic in order to mimic the elastic modulus of native arterial elastin. An IR spectroscopic analysis, especially with respect to the C═C stretch at 1650-1680 cm⁻¹ of the methacrylamide-functionalized elastin led to an estimate of the % of cross linkage (based on Peak deconvolution) at about 53 to 64%.

Electrospinning was also used to produce acrylate modified fibers and fabric networks of crosslinked gelatin. The description of the apparatus has been provided in detail in the previous section. The field strength, deposition distance and flow rate were kept constant at 18 kV, 10 cm, and 30 μL/min respectively. 18-kV field strength and 10-cm deposition distance seemed to provide the best fiber splays, while increasing the flow rate beyond 30 μL/min lead to the formation of droplets. Fibers formed from both unmodified gelatin and acrylate modified gelatin using the aforementioned parameters were analyzed with scanning electron microscopy to delineate their morphology. The concentration of gelatin in solution was found to be the major variable affecting fiber morphology.

SEM micrographs of unmodified gelatin fibers electrospun from a 25 wt % solution show that uniform fibers in the 200-500 nm diameter range were produced. For SEM examination of fibers spun from 15 and 20 wt % solutions of acrylated gelatin containing standard concentration of the photoinitiator, the fibers formed from the 15 wt % solution showed significant beading. Beading in electrospun fibers is undesirable and lead to poor mechanical properties. Reneker et. al have reported that addition of NaCl to the solution mixture decreases the beads formed during electrospinning. However, the fibers formed from the 20 wt % solution of gelatin methacrylamide showed lesser propensity to form beads when compared to fibers formed from the 15 wt % solution. Although spinning experiments have not been carried out on 25 wt % solutions of the acrylated gelatin, the fibers formed from 25 wt % unmodified gelatin in water suggest that increasing concentration will yield non-beaded fibers obviating the need for the addition of NaCl or any other salt. The fiber diameters in case of the acrylate modified samples were in the 500 to 1500 nm diameter range. The significant increase in the fiber diameter in the acrylated fibers is due to bead formation.

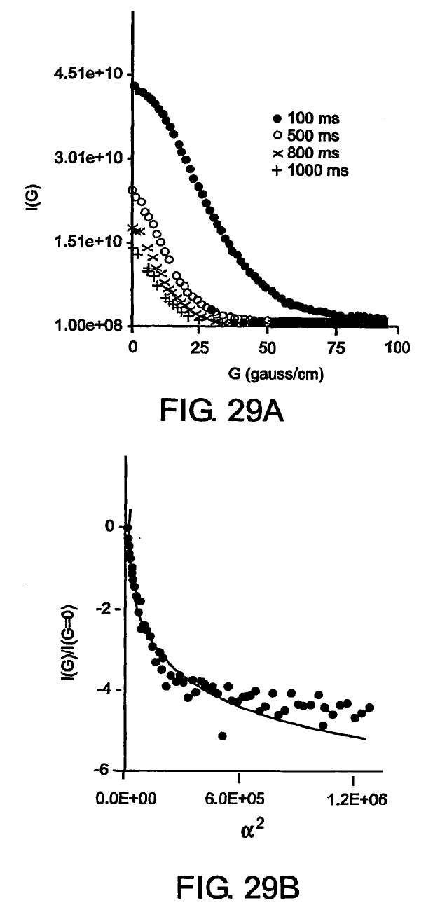

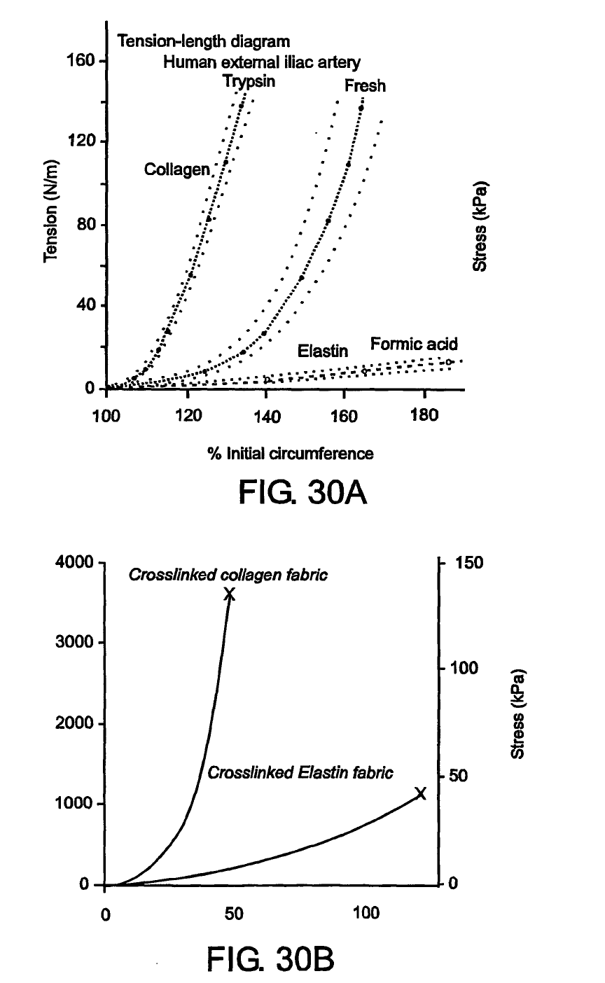

Electrospinning for extended periods of time will yield a nonwoven fabric network that consists of nano-diameter fibers. However, if a rotating mandrel is used instead of a plate, a nonwoven tube of crosslinked gelatin can be produced. FIG. 29A shows a nonwoven tube of crosslinked gelatin, 5 cm in length and 14 mm in diameter. The diameter of the tubes can be varied by increasing or decreasing the size of the mandrel. FIG. 29B also shows the tube in the hydrated state (i.e., immersed in water). The tube retains its shape even after prolonged immersion in water, idicating that the crosslinking reaction has proceeded to completion. Thus using the electrospinning method and the chemistry outlined one can begin to form constructs, which may have applications in the medical field.

The network porosity of the nonwoven fabrics was measured using pulsed field gradient NMR spectroscopy (PFGNMR). In the case of free diffusion through Brownian motion, a concentration gradient initially having the form of a pulse will gradually become Gaussian with time. However in case of diffusion in a confinement or pore, the concentration profile does not become Gaussian due to the limitation imposed by the pore boundaries. At a time when the diffusion profile in the pore becomes independent of time, it becomes a measure of the pore radius or size if the self diffusion coefficient (D) of the fluid is known a priori. PFGNMR utilizes this concept for the measurement of pore sizes.

FIG. 29A shows the diffusion profiles measured as a function of the magnetic field gradient strength (G) for varying lengths of time. It can be observed that the profiles measured at 800 ms and 1000 ms are almost similar indicating that the diffusion profile has equilibrated with time. Thus, the 1000-ms diffusion profile can be used to determine the pore size. In FIG. 29B the normalized intensity is plotted as a function of a parameter α² that is given by

$${α}^{2} = \frac{{γ}^{2} {δ}^{2} {G}^{2}}{5} ,$$

where γ_is the gyromagnetic ratio, G the magnetic field gradient and δ is the time between gradients. In the case where the pore sizes are uniform, a plot of normalized intensity versus α² would be linear with a slope that is related to the pore size. It is clearly seen from the figure that the plot is nonlinear suggesting a distribution of pore sizes. In order to determine an average pore size one can use any distribution that is realistic and fits the data well. In this case we have employed a Gaussian distribution of pore sizes. The mathematical relationship between the diffusion profile and the pore radius in the case of a Gaussian distribution of pore sizes has already been determined by Callaghan et. al.

$$ln \frac{I ( G )}{I ( G = 0 )} = - {α}^{2} {{R}_{0}^{2} [ 1 + {σ}^{2} {α}^{2} ]}^{- 1} - \frac{1}{2} ln [ 1 + {σ}^{2} {α}^{2} ] \qquad ( 1 )$$

where R₀ is the mean pore radius, and σ² is the twice the variance of the distribution. FIG. 10(b) shows the fit using (1) to the 1000-ms data. Nonlinear optimization module of Mathematica software was used for fit. From the fit, an average pore size of 73.4 μm with a standard deviation of 33.6 μm was obtained.

Monoclonal or polyclonal antibodies, preferably monoclonal, specifically reacting with a particular protein of interest may be made by methods known in the art. See, e.g., Harlow and Lane (1988) Antibodies: A Laboratory Manual, Cold Spring Harbor Laboratories; Goding (1986) Monoclonal Antibodies: Principles and Practice, 2d ed., Academic Press, New York.

Standard techniques for cloning, DNA isolation, amplification and purification, for enzymatic reactions involving DNA ligase, DNA polymerase, restriction endonucleases and the like, and various separation techniques are those known and commonly employed by those skilled in the art. A number of standard techniques are described in Sambrook et al. (1989) Molecular Cloning, Second Edition, Cold Spring Harbor Laboratory, Plainview, N.Y.; Maniatis et al. (1982) Molecular Cloning, Cold Spring Harbor Laboratory, Plainview, N.Y.; Wu (ed.) (1993) Meth. Enzymol. 218, Part I; Wu (ed.) (1979) Meth Enzymol. 68; Wu et al. (eds.) (1983) Meth. Enzymol. 100 and 101; Grossman and Moldave (eds.) Meth. Enzymol. 65; Miller (ed.) (1972) Experiments in Molecular Genetics, Cold Spring Harbor Laboratory, Cold Spring Harbor, N.Y.; Old and Primrose (1981) Principles of Gene Manipulation, University of California Press, Berkeley; Schleif and Wensink (1982) Practical Methods in Molecular Biology; Glover (ed.) (1985) DNA Cloning Vol. I and II, IRL Press, Oxford, UK; Hames and Higgins (eds.) (1985) Nucleic Acid Hybridization, IRL Press, Oxford, UK; and Setlow and Hollaender (1979) Genetic Engineering: Principles and Methods, Vols. 1-4, Plenum Press, New York. Abbreviations and nomenclature, where employed, are deemed standard in the field and commonly used in professional journals such as those cited herein.

All references cited in the present application are incorporated by reference herein to the extent that they are not inconsistent with the present disclosure.

The following examples are provided for illustrative purposes, and are not intended to limit the scope of the invention as claimed herein. Any variations in the exemplified articles which occur to the skilled artisan are intended to fall within the scope of the present invention.

### EXAMPLES

### Example 1

### Production of the Synthetic Elastin

An elastin-mimetic synthetic protein ((-Val-Pro-Gly-Val-Gly-)₄(-Val-Pro-Gly-Lys-Gly-))₃₉ of molecular weight 81 kDa was synthesized by a recombinant genetic engineering method, the details of which have been reported elsewhere McMillanet al. (1999) Macromolecules 32: 3643-3648; McMillan, R. A. and Conticello, R. P. (2000) Macromolecules 33: 4809-4821; McMillan et al. (1999) Macromolecules 32: 9067-9070]. A concatameric synthetic gene of 3000 base pairs encodes a repetitive polypeptide comprising 39 repeats of the elastin-mimetic sequence. The protein polymer was expressed from recombinant plasmid pRAM1 in E. coli strain BLR(D)E3) under the regulatory control of a Lac promoter with isopropyl β-thiogalactopyranoside induction. It was purified to a high yield (64 mg/L) by reversible, temperature-induced precipitation from the cell lysate. The sequence of the protein polymer has been confirmed by automated Edman degradation and MALDI-TOF mass spectroscopy of site-specific proteolytic cleavage fragments. Structural analysis of this recombinant protein has also included SDS PAGE, as well as ¹H and ¹³C NMR [McMillan et al. (1999) Macromolecules 32: 3643-3648; McMillan, R. A. and Conticello, R. P. (2000) Macromolecules 33: 4809-4821].

### Example 2

### Other Materials

Low molecular weight silicone oils from Brookfield Engineering Laboratories, Inc. were used as standards for measurements of solution viscosity.

Methacryloyl anhydride, eosin Y (EY, 5 wt % in water), triethanolamine (TEA) and 1-vinyl-2-pyrrolidinone (VP) were obtained from Aldrich (Milwaukee, Wis.) and were used as received. A UV sensitive radical photoinitiator 1-(4-(2-hydroxyethoxy)phenyl)-2-hydroxy-2-methyl-1-propan-1-one (Irgacure 2959) was kindly supplied by Ciba Speciality Chemicals (Tarrytown, N.Y.). Dialysis was conducted using Spectra/pro membrane (MWCO 6000-8000) obtained from VWR Scientific (West Chester, Pa.).

Poly(ethylene oxide) (PEO) with a nominal molecular weight of 900 kD was obtained from Aldrich. Acid-soluble collagen was derived from tail tendons obtained from Sprague-Dawley rats weighing between 250 to 350 grams using a protocol similar to that described by Silver and Trelstad.¹⁹ Briefly, tendon fibers were extracted from rat tails using a wire stripper, immersed in 10 mM HCl (pH 2.0; 10 fibers per 100 mL), and stirred for 4 hours at room temperature. The soluble component was separated from the insoluble portion after centrifugation at 30,000 g at 4° C. for 30 min and then sequentially filtered through 0.65 and 0.45 μm filters (Millipore Corp., Bedford, Mass.). NaCl was added to the filtrate so as to obtain a salt concentration of 0.7 M. The mixture was then allowed to stir for 1 hour and the precipitate collected after an one-hour centrifugation at 30,000 g and 4° C. The pellet was allowed to dissolve overnight in 10 mM HCl (pH 2.0) and dialyzed against 20 mM phosphate buffer (disodium hydrogen phosphate at pH 7.4) for at least 8 hours at room temperature. A second dialysis was then performed against a 20 mM phosphate buffer solution for at least 4 hours at 4° C. The dialyzate was centrifuged at 30,000 g at 4° C. for 1 hour and the pellet was then dialyzed overnight against a solution of 10 mM HCl (pH 2.0) to obtain a collagen solution at a final concentration of 10 mg/mL. The solution was stored at 4° C.

Lyophilized collagen was obtained by dialyzing the collagen solution overnight against distilled, deionized water (18 MΩ·cm, Continental), followed by lyophilization. Prior to use, lyophilized collagen was dissolved in 10 mM HCl at room temperature for 1 hour. The identity and purity of the collagen samples was confirmed by polyacrylamide gel electrophoresis.

Gelatin (Type A—Porcine Skin, 300 Bloom; product #G-2500) and 2,2,2-trifluororethanol were purchased from Sigma Chemical Inc., St. Louis, Mo. Methacryloyl anhydride (94%), Eosin-Y 5 wt. % in water, 1-vinyl-2-pyrrolidinone (99+%), and triethanolamine (98%) were purchased from Aldrich Chemical Inc., Milwaukee, Wis. Phosphate buffer used was an aqueous solution of sodium dihydrogen phosphate, monohydrate (J.T. Baker Inc., Phillipsburg, N.J.) and disodium hydrogen phosphate (Fisher Scientific, Fair Lawn, N.J.).

### Example 3

### Fiber Spinning

Elastin-mimetic peptide polymers were spun into fibers using an electrospinning technique, as detailed elsewhere. Briefly, peptide polymer solutions (10-15 wt %) were prepared in ultrafiltered grade, distilled, deionized water (18 MΩ·cm, Continental) by mixing for 12 hrs at 4° C. With the aid of a syringe pump (Harvard Apparatus, Inc., Holliston, Mass.), the solution was extruded at ambient temperature and pressure and at a defined flow rate through a positively charged metal blunt tipped needle (22 G×1.5 inch). The needle was connected to a 1 mL syringe using Tygon™ (trademark of San Diego Plastics, Inc. National City, Calif., plastic tubing) tubing (1.6 mm i.d.). Fibers were collected on a grounded aluminum plate located below the tip of the needle. A high voltage, low current power supply (ES30P/DDPM, Gamma High Voltage Research, Inc., Ormand Beach, Fla.) was utilized to establish the necessary electric potential gradient, which was varied between 0 and 30 kV as indicated. Either positive or negative polarity can be used to run the electrospinning process. Vₛₜₐᵣₜ and Vₛₜₒₚ, defined as the electric potential necessary to in itiate or terminate jet formation, respectively were determined for different concentrations of elastin-mimetic polypeptide solutions.

Fabric samples were produced by electrospinning solutions for extended periods of time. The apparatus was modified to include a rotating mandrel to produce fabric samples. The fabric samples were collected on an aluminum foil wrapped around the grounded mandrel placed at a prescribed horizontal distance with respect to the charged tip of the needle.

Collagen-PEO solutions (1-2 wt %) were prepared in 10 mM HCl (pH 2.0) by mixing for 2 hours at ambient temperature. With the aid of a syringe pump (Harvard Apparatus, Inc.), the solution was extnded at ambient temperature and pressure and at a defined flow rate through a positively charged metal blunt tipped needle (22G×1.5 inch). Fibers were collected on a grounded aluminum plate located below the tip of the needle. A high voltage, low current power supply (ES30P/DDPM, Gamma High Voltage Research, Inc) was utilized to establish the electric potential gradient, which was varied between 0 and 30 kV, as indicated.

### Example 4

### Synthesis of Methacrylate-Modified Elastin and Fiber Spinning

The procedure for acrylate modification of amino-containing compounds developed by Van den Bulcke et al. was followed [Van Den Bulcke et al. (2000) Biomacromolecules 1: 31]. The elastin-mimetic polypentapeptide was dissolved in pH 7.5 phosphate buffer solution. The solution was cooled to 5° C. and an excess of methacryloyl anhydride was added. The reaction was allowed to proceed for 8 hours. The reaction mixture was diluted and was dialyzed against distilled water at room temperature for 48 hours with frequent changes in the dialyzate solution. The dialyzate was subsequently freeze-dried and stored at room temperature. The degree of functionalization (DOF) was defmed as the ratio of amino moieties functionalized to the total number of amino moieties in elastin prior to functionalization. DOF could be varied by changing the methacryloyl anhydride to elastin ratio.

Electrospinning was used to spin fibers of AME from aqueous solutions. Solution concentration, flow rate and operating voltage were found to be the critical parameters affecting the spinning process. The details of the technique and optimization of process parameters to yield smooth nanofibers have been discussed in detail in an earlier report. [Huang et al. (2000) Macromolecules 33, 2989]. A solution of 10-15 wt % AME(65) polymer in ddH20 was prepared with the addition of 5 wt % (of the protein polymer content) of triethanolamine, as free radical crosslinker. For example, to each 100 mgs of protein polymer, 5 mgs of triethanolamine or approximately 50 μL of the stock EY/TEA/VP solution was added. A field strength of 18 kV was chosen for fiber formation and the distance between the syringe tip and the collecting plate was fixed at 15 cm. The flow rate was 50 μl/min. A stock solution of EY photoinitiator was prepared as 10 mM EY, 225 mM TEA, and 37 mM VP in water. Irgacure 2959 was directly added to the prepared protein solution.

For the purpose of crosslinking studies four samples of 15 wt % AME(65) solution in ddH₂O were prepared. Eosin Y was added to the first solution (amount of photoinitiator corresponded to 3 wt % of the protein in solution) and IRGACURE 2959® was added to the second (amount of photoinitiator corresponded to 6 wt % of the protein in solution). In order to ensure uniform dispersion of the photoinitiator, both solutions were stirred in the dark for 12 hours. Additional samples that did not contain photoinitiator were irradiated and used for comparative analysis. All samples were dried under vacuum for 24 hours. Subsequent to drying, the Eosin Y and Irgacure containing samples were irradiated under visible light for 45 minutes and UV light (365 nm) for 30 minutes, respectively.

### Example 5

### Preparation of Non-Woven Acrylated Gelatin Fabrics

To prepare acrylate modified gelatin, a 5-weight % solution of gelatin was made in 10 mM phosphate buffer solution, pH 7.5. To this solution a four times excess of methacryloyl anhydride (in relation to target amino acid residues) was added to the solution. The reaction was then stirred at 40° C. for 4 hours. The solution was then dialyzed using a Spectra/Por membrane (MWCO: 6-8,000) against 60 volumes of ddH₂O at 40° C. for 48 hrs with constant changes in the dialyzing solution. The solution was then lyophilized and the dialyzate was stored at −30° C.

5% weight solutions (150 mg of acrylated gelatin in 1278 μL ddH₂O/222 μL photo initiator solution) were prepared and plated into 29.14 cm² polystyrene dishes. Solutions were made using the standard, medium and high photoinitiator preparations. The solvent was allowed to evaporate at room temperature (24° C., 43% relative humidity). After drying, the samples were exposed to a visible light source (Dyna-Lume “dyna-light” #240-380, 70 mW/cm²) for various periods from 30 minutes to 3½ hours for crosslinking. The films were then prepared for mechanical testing as outlined earlier.

The gelatin electrospinning apparatus consisted of a syringe pump (Harvard Apparatus), a syringe, an 18 gauge blunt end needle (Popper and Sons, Inc.), a grounded rotating metallic 14 mm O. D. mandrel (for production of tubes), a grounded 10 cm by 10 cm aluminum covered plate (for flat fabric production), an electric mandrel rotor, a Dyna-Lume “dyna-light” #240-380, and a high voltage source (Gamma High Voltage, HV power supply, c.f., FIG. 1(a)). Solutions of gelatin and acrylated gelatin (150 mgs) were prepared in concentrations from 10 wt % to 25 wt % in ddH₂O along with 222 μL of the high concentration photo initiator solution. The syringe containing the acrylated gelatin/photo initiator solution was shielded during spinning with an opaque tape to prevent premature crosslinking. The needle was heated using a heating lamp to avoid gelation in the needle and to maintain uniform flow rate. The temperature profile across the syringe and the needle was obtained with a type K thermocouple. Temperature readings were obtained across four points (labeled T₁ through T₄ in the figure) in the syringe. The profiles were measured after steady state had been achieved. By varying the setting on the heat lamp, the temperature in the needle could be adjusted to desired levels. The temperature was maintained between 45 and 55° C. The applied field of 18 kV and deposition distance of 10 cm were kept constant for all runs. A flow rate of 30 μL/min was maintained during electrospinning, because flow rates in excess of 30 μL/min produced droplets. The fibers on deposition were exposed to light throughout the spinning process and for an additional two hours after fiber spinning had ceased. To function as a release agent a layer of polyethylene oxide (MW ^{˜}900 kDa) was deposited on the alumimim foil to achieve a 100 μm thick covering. The acrylated gelatin fibers were then deposited on top of the PEO layer. Deposition time varied depending on the volume of material to be spun.

### Example 6

### Image Capture of Non-Woven Fabric Samples and Analysis of Fiber Diameter and Orientation Distribution

Fabrics were generated by electrospinning at a 150 μl/min from a 15 wt % solution of elastin-mimetic peptide polymer. Specimens were placed directly on a mirror and imaged using a directional lighting arrangement where light is collimated using an “on-axis” system comprised of both a diffuser and a beam-splitter. Light passes through the sample and is reflected vertically off the mirror surface back to a CCD camera. Specular reflections from fiber surfaces do not reach the camera. Thus, fibers, regardless of their position within the fabric, merely block the light, appear dark, and are in focus. Captured images underwent segmentation or “threshholding” in order to isolate individual fibers from background. In this process, local contrast enhancement procedures were utilized including relaxation and edge thresholding techniques. Analysis also required skeletonizing of the image in which the backbone of individual fibers, corresponding to an image one pixel wide, was determined. Skeletonizing requires generating a “distance map” of the image that represents the minimum distance from each pixel belonging to an object to the background. Therefore, the highest value in the distance transform image correlates with the object center, and the peak line coincides with the axis or skeleton of the object. By using the skeleton as a guide for tracking the distance transformed image, the intensities (distances) from the fiber center to background can be determined in order to compute the diameter at all points along the skeleton. Similarly, fiber orientation is characterized by utilg a chord-tracking algorithm, which tracks fixed small segments of individual fibers. Details of these automated image analysis techniques, as applied to fiber networks in the form of non-woven fabrics, are provided elsewhere [Pourdeyhimi et al (1999) Textile Res. J. 69: 233-236; Pourdeyhimi et al (2001) Textile Res. J. 71: 157-164]. Analysis of fiber diameter and orientation distribution was based upon a minimum of 10 image fields obtained from at least two separate samples.

### Example 7

### Stress-Strain Properties of Non-Woven Fabrics

Uniaxial tensile tests were performed elastin-mimetic materials on a Textechno Favimat (Herbert Stein GmbH & Co. KG, Germany). Dry samples were tested at an extension rate of 5 mm/min and an initial gauge length of 10 mm. The maximum range of the load cell is 210 cN. A total of eight samples were analyzed.

Uniaxial tensile testing of collagen/PEO material was performed on a Minimat 2000 (Miniature Materials Tester, Rheometric Scientific, Inc., Piscataway, N.J.). Dry collagen-PEO fabric samples were tested at an extension rate of 2 mm/min and at an initial gage length of 8 mm. The maximum range of the load cell is 20 N. A total of six samples were analyzed. Samples thickness was determined by use of a profilometer (Tencor Alphastep 500) at different points along the sample and an average sample thickness of 0.05 mm was obtained. The samples were cut at a width of 5 mm.

A miniature materials tester Minimat 2000 (Rheometric Scientific, Piscataway, N.J.) was used to determine the tensile properties of the unmodified and the modified elastin fabrics. The machine was used in the tensile deformation mode with a 20N load cell and a strain rate of 1 mm/min. Fabric samples (10 mm×1.5 mm×0.05 mm) were used as test specimens with a gauge length of 8 mm. For each sample, eight specimens were tested and average modulus and tensile strength values were determined.

### Example 8

### Instrumentation

All ¹H NMR spectra were recorded at room temperature on a Bruker AMX 500 spectrometer operating at a ¹H resonance frequency of 500 MHz. Thirty-two scans were acquired for signal-to-noise averaging. A recycle delay of 30 seconds was used to ensure quantitative spectra. In all cases D₂O was used as the internal standard and a concentration of 10 mg/ml was employed.

All solid-state NMR experiments were conducted at room temperature on a Bruker DSX 300 spectrometer operating at a ¹H resonance frequency of 300 MHz in a Bruker double resonance MAS probehead. Standard cross polarization (CP) pulse sequence was employed under conditions of magic angle spinning (MAS). A spinning speed of 5 kHz was employed. A TOSS sequence was used in conjunction with CP to provide a spectrum free of spinning sidebands [Dixon, W. T. (1982) J. Chem. Phys. 77, 1800; Dixon et al. (1982) J. Magn. Reson. 49, 341]. A 4.5-μs ¹H 90° pulse, a 1-ms contact time, a 9-μs ¹³C 180° pulse and a 3-sec recycle delay were employed with 5000-16000 scans accumulated for signal averaging.

In studies of collagen fibers, all ¹H NMR spectra were recorded at room temperature on a Bruker AMX 500 spectrometer operating at a ¹H resonance frequency of 500 MHz. Thirty-two scans were acquired for signal-to-noise averaging and a recycle delay of 30 seconds was used to ensure quantitative spectra. In all cases D₂O was used as the internal standard and a concentration of 10 mg/mL was employed.

All solid-state NMR experiments were conducted at room temperature on a Bruker DSX 300 spectrometer operating at a ¹H resonance frequency of 300 MHz in a Bruker double resonance MAS probehead. Standard cross polarization (CP) pulse sequence was employed under conditions of magic angle spinning (MAS). A spinning speed of 5 kHz was employed. A TOSS sequence was used in conjunction with CP to provide a spectrum free of spinning sidebands.²⁰ A 4.5-μs ¹H 90° pulse, a 1-ms contact time, a 9-μs ¹³C 180° pulse, and a 3-sec recycle delay were employed with accumulation of 5000 to 16000 scans for signal averaging. Direct polarization (DP) experiments were conducted with a recycle delay of 1 s, a ¹³C 90° pulse length of 4.5 μs, and a MAS rate of 5 kHz. For DP experiments, 1024 scans were acquired.

¹H dipolar magnetization transfer experiments were conducted under static conditions (without magic-angle sample spinning). Recycle delays of 5 s, ¹H 90° pulse lengths of 4.5 μs, and ¹H 180° pulse lengths of 9 μs were used. The timing diagram for the spin diffusion pulse sequence has been reported in detail elsewhere. A dipolar filter selection sequence consisting of twelve 90° pulses separated by 10-μs delays was employed for 20 consecutive loops to establish the initial magnetization gradient. Thirty-two scans were accumulated for signal averaging and the spin diffusion time (t_{SD}) was incremented from 1 μs to 800 ms. Correction for spin-lattice relaxation during the spin diffusion time was achieved by repeating the experiment with the selection filter removed (# dipolar filter cycles, n=0). The data acquired with and without the selection cycles were normalized with respect to the first time point and the spectral intensity corresponding to the mobile domain. The ratio of I_{PEO} (with selection) to I_{PEO} (without selection) provided the spin diffusion data as a function of t_{SD}.

In order to examine the chemical structure of the component selected using the dipolar filter, a CP sequence was appended to the dipolar filter sequence. For this experiment, a 3-sec recycle delay, a 4.5-μs ¹H 90° pulse, and a 1-ms contact time were used. The experiment was conducted under conditions of MAS with a spinning speed of 5 kHz and 10,000 scans were acquired for signal averaging.

Temperature-dependent turbidimetry measurements were recorded in an Ultrospec 3000 UV/visible spectrophotometer equipped with a programmable Peltier Cell and temperature control unit from μmersham Pharmacia Biotech, Inc. (iscataway, N.J.). Inverse temperature transitions of elastin-minetic polypentapeptide and its acrylate modified analogs were monitored in ddH₂O solution (concentration of 0.5-0.7 mg/ml) at 280 nm.

An in-lens field emission scanning electron microscope (ISI DS-130F Schottky Field Emission SEM, York Electron Optics Ltd., York, UK) was used and operated at 5 or 25 kV. High-definition topographic images at low (^{˜}1,000×) and medium (30,000×) magnifications and high resolution, and high magnification images (≧100,000×) were digitally recorded with very short dwell times and without beam induced damage. Fiber samples were deposited onto silicon chips for SEM studies. The silicon chips were subsequently mounted onto aluminum specimen stubs with silver paste, degassed for 30 minutes, and coated with a 1 nm chromium (Cr) ultrathin film using a Denton DV-602 Turbo Magnetron Sputter System.

For transmission electron microscopy (TEM) imaging a JEOL 1210 TEM was operated at 70 kV voltage. Fiber samples were deposited onto silicon chips and carbon coated grids for scanning and transmission EM studies, respectively. Samples containing silicon chips were subsequently mounted onto aluminum specimen stubs with silver paste, degassed for 30 minutes, and coated with a 1 nm chromium (Cr) ultrathin film using a Denton DV-602 Turbo Magnetron Sputter System.

Visible light irradiation was performed using a DynaLume quartz halogen illuminator equipped with a heat shield obtained from Scientific Instruments. Ultraviolet irradiation was performed with an UVP 8-watt handheld model (model UVL-18) operating at 365 nm.

Bulk viscosity was determined using silicone oil viscosity standards (Brookfield Engineering Laboratories, Inc.) and solution conductivity determined using a conductivity flow cell (BIORAD, Hercules, Calif.).

TABLE I
The viscosity for the 2 wt % Lyophilized Collagen of
different PEO ratio and fixed 34 mM NaCl

| Collagen | PEO | | |
|---|---|---|---|
| Concentration | Concentration | Collagen/PEO weight | Viscosity |
| mg/ml | Mg/ml | ratio | (cp) |
| 20 | 0 | 0 | 217 |
| 20 | 0.67 | 30:1 | 289 |
| 20 | 2 | 10:1 | 475 |
| 20 | 4 | 5:1 | 592 |
| 20 | 10 | 2:1 | 1150 |
| 20 | 20 | 1:1 | 5536 |
| 20 | 40 | 1:2 | 36198 |

TABLE II
Conductivity of the 2 wt % Lyophilized Collagen
Dissolved in the HCl solution (pH = 2.0)

| | | | | Average |
|---|---|---|---|---|
| [NaCl] mM | 1 | 2 | 3 | Conductivity |
| 0 | 1.45 | 1.42 | 1.44 | 1.44 |
| 15 | 1.54 | 1.56 | 1.55 | 1.55 |
| 25 | 2.06 | 2.05 | 2.06 | 2.06 |
| 34 | 2.27 | 2.26 | 2.25 | 2.26 |

TABLE III
The ultimate tensile strength and modulus of pure PE,
collagen/PEO of 1:1 and 1:2 weight ratio nonwoven
fabric samples

| Fabric Samples | Tensile Strength (Mpa) | Modulus (Gpa) |
|---|---|---|
| Pure PEO | 0.09 | 0.007 |
| 1:1 Collagen/PEO | 0.37 | 0.012 |
| 1:2 Collagen/PEO | 0.27 | 0.008 |

What is claimed is:

1. A fiber, fiber network or nonwoven fabric comprising at least one cross linked protein selected from the group consisting of elastin, an elastin mimetic protein, gelatin and collagen.

2. The fiber, fiber network or nonwoven fabric of claim 1 further comprising a synthetic polymer.

3. The fiber, fiber network or nonwoven fabric of claim 2 wherein the synthetic polymer is water soluble polymer.

4. The fiber, fiber network or nonwoven fabric of claim 3 wherein the water soluble polymer is poly(ethylene oxide).

5. The fiber, fiber network or nonwoven fabric of claim of claims 1 to 4 wherein the cross linked protein is formed from a functionalized protein, wherein a functional group is selected from the group consisting of acrylamide moiety, a methacrylamide moiety and a vinyl group.

6. The fiber, fiber network or nonwoven fabric of claim 5 wherein the functional moiety is a vinyl group or a methacrylamide and wherein cross linking is mediated by a photoinitiator and photoirradiation.

7. The fibers, fiber network or nonwoven fabric of claim 4 or 5 wherein the crosslinking is mediated by glutaraldehyde.

8. The fiber network or nonwoven fabric of claim 5 wherein the fibers are present as alternating layers of cross linked collagen and cross linked gelatin.

9. The fiber network or nonwoven of claim 5 wherein the fibers are present as alternating layers of cross linked collagen and cross linked elastin or cross linked elastin mimetic protein.

10. The fiber network or nonwoven fabric of claim 10 wherein the proteins are cross linked after layering of the cross linked collagen and cross linked gelatin.

11. The fiber network or nonwoven fabric of claim 10 futer comprising living cells.

12. The fiber network or nonwoven fabric of claim 11 wherein the living cells are selected from the group consisting of endothelial cells, smooth muscle cells, fibroblasts, stem cells, chondrocyytes, osteoblasts. or a human or animal cell which has been transformed or transfected to produce a protein of interest.

13. The fiber, fiber network or nonwoven fabric of claim 3 wherein the fiber formed of cross linked collagen and poly(ethylene) oxide.

14. The fiber, fiber network or nonwoven fabric of claim 13 further comprising at least one therapeutic compound.

15. The fiber, fiber network or nonwoven fabric of claim 14 wherein the at least one therapeutic compound promotes wound healing.

16. The fiber, fiber network or nonwoven fabric of any of claims 4 to 15 wherein said fiber network or nonwoven fabric is fabricated as a planar sheet or as a tubular conduit.

17. The use of the fiber, fiber network or nonwoven fabric of any of claims 2 to 16 in the fabrication of a medical implant or wound dressing having improved biocompatibility over non biomaterial implants.

18. The use according to claim 17 wherein the medical implant is a graft for skin, vein, artery, ureter, bladder, esophagus, intestine, stomach, heart valve, heart muscle or tendon.

19. The use of claim 17 wherein implant is used to reinforce closure of a surgical incision.

20. The use according to claim 17 wherein the surgical incision is associated with a lung biopsy or an intestinal anastomasis.
